(19) United States
(12) Patent Application Publication
(10) Pub. No.: US 2002/0060685 A1
(43) Pub. Date: May 23, 2002

(54) Method, system, and computer program product for managing terrain rendering information

(76) Inventors: Malcolm Handley, Menlo Park, CA (US); William David Harvey, Palo Alto, CA (US); Benjamin M. Werther, Palo Alto, CA (US)

Correspondence Address: STERNE, KESSLER, GOLDSTEIN & FOX PLLC, 1100 NEW YORK AVENUE, N.W., SUITE 600, WASHINGTON, DC, 20005-3934, US

(21) Appl. No.: 09/988,747

(22) Filed: Nov. 20, 2001

Related U.S. Application Data
(63) Continuation-in-part of application No. 09/560,564, filed on Apr. 28, 2000.
(63) Continuation-in-part of application No. 09/560,886, filed on Apr. 28, 2000.
(60) Provisional application No. 60/289,584, filed on May 9, 2001.

(51) Int. Cl. G09G 5/00

(52) U.S. Cl. 345/582

(57) ABSTRACT

The present invention provides a method, system, and computer program product for managing terrain rendering information. The terrain rendering information includes a data structure of render blocks. The data structure represents a three-dimensional terrain topology of a virtual world with a set of two-dimensional terrain topologies. Each render block includes primitives that define samples of a respective area of terrain to be rendered. A render block manager manages the allocation of render blocks in the data structure based on current reference point information and allocation criteria. Terrain data at higher levels of detail (that is, a greater resolution) is kept closer to the reference point information by adding and removing appropriate render blocks. In this way, appropriate terrain rendering information is maintained efficiently in the data structure during movement of a reference point. Terrain data to be rendered is managed at interactive rates for a large terrain area having a complex shape, such as, a sphere.

### CROSS-REFERENCE TO RELATED APPLICATIONS

This application claims the benefit of priority to the following commonly-owned and co-pending applications:

1. Method, System, and Computer Program Product for Managing Terrain Rendering Information, U.S. Provisional Application, Application No. 60/289,584, filed May 9, 2001 by M. Handley et al. (incorporated in its entirety herein by reference);

2. Method, System, and Computer Program Product for Managing, Rendering and/or Administering Terrain Data, Application Ser. No. 09/560,564, filed Apr. 28, 2000 by B. Werther et al. (incorporated in its entirety herein by reference); and

3. Synthetic Terrain Generation Including Fractal Terrain Generation and Terrain-Type Data Generation, Application Ser. No. 09/560,886, filed Apr. 28, 2000 by W. Harvey et al. (incorporated in its entirety herein by reference).

### BACKGROUND OF THE INVENTION

1. Field of the Invention

The present invention relates to computer-generated terrain.

2. Background Art

Terrain visualization at interactive rates is increasingly desired in computer-generated scenes. Many applications use terrain in scenes to increase realism and visual appeal. Height fields defined on a pre-defined grid are often used to represent terrain. At interactive rates, different types of geometric data, including terrain, compete for a limited set of primitives (e.g., triangles). Terrain is especially difficult because, inter alia, it does not naturally divide into separate parts and associated triangulation is view-dependent. See, e.g., Duchaineau, “ROAMing Terrain: Real-Time Optimally Adapting Meshes,” section 1, http:/www.llnl.gov/graphics/ROAM, last modified Oct. 19, 1997.

To enable a high frame rate, the number of triangles rendered needs to be limited for each frame. The triangle count needs to be manageably low through successive frame updates. This is especially true for dynamic terrain visualization on current consumer graphics hardware. Terrain data associated with new triangles in a scene needs to be added at interactive rates. This is difficult as the complexity and size of the terrain data increases. Algorithms have been proposed to interactively, perform view-dependent, locally-adaptive terrain triangulation (or meshing). For example, the so-called “ROAM algorithm” uses a triangle bin tree mesh representation, two priority queues to drive split/merge operations, and incremental features (view-frustum culling, incremental T-stripping, and deferred priority recomputation). See, Duchaineau, entire paper. Such algorithms, however, have not been extended to a large terrain area having a complex shape, such, as the Earth's surface. Terrain data other than height fields have not been handled in these algorithms.

Further, many leading-edge terrain renderers currently use the ROAM algorithm. The ROAM algorithm was developed under the assumption that triangles are expensive to draw. Accordingly, expensive work was performed to place individual triangles of a terrain optimally with respect to a scene being rendered.

Terrain rendering information is needed which does not require expensive individual triangle management. What is needed is a method, system, and computer program product that can manage terrain rendering information with less individual triangle management than found in the ROAM algorithm.

### BRIEF SUMMARY OF THE INVENTION

The present invention provides a method, system, and computer program product for managing terrain rendering information. The terrain rendering information includes a data structure of render blocks. The data structure represents a three-dimensional terrain topology of a virtual world with a set of two-dimensional terrain topologies. Each render block includes primitives, such as, triangles, that define samples of a respective area of terrain to be rendered.

The data structure of render blocks is managed to maintain appropriate terrain samples at a current reference point, such as, a current camera position.

In one embodiment, the three-dimensional terrain topology of the virtual world is a spheric terrain topology and the set of two-dimensional terrain topologies represent six faces of a cube. The data structure of render blocks is then made up of six quad trees. Each quad tree corresponds to a respective cube face.

A terrain renderer includes a storage device and a render block manager.

The storage device stores a data structure with allocated render blocks. The render block manager manages the allocation of the render blocks in the data structure. The render block manager manages the allocation of render blocks based on current reference point information and allocation criteria. Terrain data at higher levels of detail (that is, a greater resolution) is kept closer to the reference point information by adding and removing appropriate render blocks.

In this way, appropriate terrain rendering information is maintained efficiently in the data structure during movement of a reference point. For example, render blocks are added and removed to track changes in the camera position in scene to be rendered in a real-time application.

In one embodiment, the render block manager manages the allocation of render blocks in the data structure based on at least one allocation criterion. One example allocation criterion is the distance of a candidate render block from a current reference point information. Larger distances are considered less important than smaller distances. A render block which is relatively far from a reference point (i.e., a larger distance) is considered less important and more likely to be removed or not added to a data structure than a render block closer to the reference point (i.e, a smaller distance). Another allocation criteria is a maximum budget of render blocks. The maximum budget can be set on a per level or per data structure basis. Render block manager adds or removes a number of candidate render blocks while not exceeding the maximum budget of render blocks set on a per level or per data structure basis. Other allocation criteria used in the addition and removal of render blocks include size of a candidate render block, recent visibility of a candidate render block, presence of parent render block, and a level difference constraint. Allocation criteria used in the removal of render blocks further includes presence of a child render block for the candidate render block and presence of a child render block for a neighbor render block of the candidate render block.

Each allocation criterion can be used alone or in combination with one or more other allocation criteria in determining whether to add or remove candidate render blocks to and from a data structure. In one example, the render block manager manages the allocation of render blocks in the data structure based on at least the distance of a candidate render block from a current reference point information. In another example, the render block manager manages the allocation of render blocks in the data structure based on a distance of a candidate render block from current reference point information, a level difference constraint, and a maximum budget of render blocks. In another example, the render block manager manages the allocation of render blocks in the data structure based on at least one allocation criterion selected from the group of: distance of a candidate render block from current reference point information, size of a candidate render block, recent visibility of a candidate render block, presence of parent render block, presence of a child render block for the candidate render block, presence of a child render block for a neighbor render block of the candidate render block, a level difference constraint, and a maximum budget of render blocks. The maximum budget of render blocks can be based on a maximum number of render blocks allowed per level of each quad tree or a maximum number of render blocks allowed in total for each quad tree.

Each render block includes primitive data and a texture identifier. The primitive data includes primitives defining an area of terrain to be rendered. In one example, an area of terrain to be rendered for a render block has four quadrants. The primitive data includes four triangle lists corresponding to vertices of terrain samples in the respective quadrants. Th texture identifier identifies a texture to be applied in rendering the area of terrain defined by the primitive data.

Each render block in a quad tree data structure further includes a parent pointer, zero to four child pointers, a render block address in a two-dimensional space of a respective cube face, and a set of vertex locations in a three-dimensional coordinate space.

The render block manager initializes the data structure and fills each allocated render block with corresponding render block information. For each render block to be added to the data structure, the render block manager fetches two-dimensional terrain data from a terrain data source, and converts the fetched two-dimensional terrain data from a cube face space into the set of three-dimensional vertex locations in a three-dimensional world space of a sphere. The render block manager further determines a texture identifier and generates the four triangle lists.

In one embodiment, functionality of the render block manager is carried out by a render block allocator and a render block generator. The render block allocator identifies render blocks to be added or removed from the data structure based on current reference point information and allocation criteria. The render block allocator further includes a distance calculator that determines a distance between two points on the same or different cube faces. The render block generator fills information in each render block to be added to the data structure.

The render block generator further includes a texture module and a triangulation module. The texture module identifies a texture for each allocated render block. A number of available textures can be pre-stored by a user and/or generated automatically by a texture creator. In one feature of the invention, a texture creator fetches terrain data made up of samples at a higher level of detail than the primitive data in a corresponding render block, generates a texture having texels at the samples of the fetched terrain data, and colors the texels based on terrain type information (such as, flora type and bumpiness information).

The triangulation module triangulates a set of vertex locations in three-dimensional coordinate space to form sets of tuples corresponding to the four quadrants of terrain represented by a render block. The triangulation module adjusts the triangulation of vertex locations at selected edges of the corners to avoid splitting. For example, the triangulation module removes extra vertex locations at edges which are a boundary between render blocks having relatively low and high level of detail.

The terrain renderer also has a cube/sphere conversion module that converts a position in a three-dimensional terrain topology of a virtual world to a position in a set of two-dimensional topologies, and vice versa.

The present invention also provides a method for managing terrain rendering information. The method includes the steps of storing a data structure to represent a three-dimensional terrain topology of a virtual world with a set of two-dimensional terrain topologies, and allocating render blocks in the data structure based on a current reference point information. Render blocks are allocated which have terrain primitive data covering an area based on the current reference point information. A managing step manages an allocation of render blocks in the data structure based on a current reference point information and/or other allocation criteria. A filling step fills each allocated render block with corresponding render block information.

In one example, a data structure comprises six quad trees corresponding to six cube faces, each quad tree having one or more levels. The managing step includes identifying one or more candidate render blocks to add and remove from each level of each quad tree based on at least one allocation criterion, and adding and removing a number of the identified candidate render blocks from a level of a quad tree based on at least one allocation criterion.

For each new render block to be added to the data structure, fetching and converting steps are performed. The fetching step fetches two-dimensional terrain data from a terrain data source. The converting step converts the fetched two-dimensional terrain data into a set of three-dimensional vertex locations. A texture creating step can also be carried out to create a texture corresponding for an allocated render block. A triangulating step triangulates a set of vertex locations in three-dimensional coordinate space to form sets of tuples corresponding to four quadrants of an area of terrain represented by a render block, and adjusts the triangulation of vertex locations at selected edges of the corners to avoid splitting.

According to a further feature of the present invention, a system and method for converting between a position in a three-dimensional terrain topology of a virtual world to a position in a set of two-dimensional topologies is provided.

In one embodiment, the method to convert positions from 3D to 2D includes the steps of: receiving a 3D position coordinate representative of the position in the three-dimensional terrain topology, normalizing the 3D position coordinate, determining a two-dimensional terrain topology based on a set of unit reference vectors, determining a fractional position within the determined two-dimensional terrain topology based on an interpolation between four corner vectors, and converting the determined fractional position to a position within the determined two-dimensional terrain topology. The method to convert positions from 2D to 3D includes the steps of receiving a position in a set of two-dimensional terrain topologies, converting the position to a fractional position within a corresponding two-dimensional terrain topology, interpolating between four corner vectors based on the fractional position to obtain a resultant vector, and scaling the resultant vector based on a reference terrain height to obtain the position in a three-dimensional terrain topology of a virtual world.

In another embodiment, the method to convert positions from 3D to 2D includes the steps of: receiving a 3D position coordinate having three coordinate values representative of the position in the three-dimensional terrain topology, comparing relative magnitudes of the three coordinate values, determining the sign of one of the three coordinate values, determining a two-dimensional terrain topology based on the comparison of relative magnitudes and the determined sign, determining a fractional position within the determined two-dimensional terrain topology based on the comparison of relative magnitudes and the determined sign, and converting the determined fractional position to a position within the determined two-dimensional terrain topology. The method to convert positions from 3D to 2D includes the steps of: receiving a position having two coordinate values representative of the position in a set of two-dimensional terrain topologies, converting the two coordinate values to a fractional position within a corresponding two-dimensional terrain topology, determining a raw position having three coordinate values based on the a two-dimensional terrain topology identifier and the fractional position, and scaling the raw position based on a reference terrain height to obtain the position in a three-dimensional terrain topology of a virtual world.

Functionality of the present invention can be carried out in software, firmware, hardware, or a combination thereof. The present invention can be used in any terrain rendering application including, but not limited to, a terrain engine provided on a stand-alone computer or a terrain engine coupled over a network to a terrain database. Embodiments of the present invention further include a computer program product and a computer data signal. The computer program product has a computer useable medium with computer program logic for enabling at least one processor in a computer system to manage rendering information. The computer data signal is embodied in a wired or wireless medium comprising computer program logic for enabling at least one processor in a computer system to manage rendering information.

One advantage of the present invention is that render blocks are managed to maintain terrain rendering information. Less individual triangle management is required compared to the approach used in the ROAM algorithm.

Another advantage is that the present invention can manage terrain data at interactive rates for a large terrain area having a complex shape, such as, a sphere. Terrain rendering management manages the allocation of render blocks to maintain active triangles and active textures for terrain data even when that terrain data potentially covers a large terrain area having a complex shape, such as, the Earth's surface.

In one embodiment, a terrain engine provides terrain primitive and texture information for rendering view-dependent scenes in frames updated at interactive rates (at rates of every several frames, every frame, or faster). Terrain data can have a topologically complex spherical shape covering a large data set such as a planet surface. Render blocks are managed and allocated, however, in a set of quad trees corresponding to six cube faces. In this way, primitives and textures for terrain are processed in render blocks at interactive frame rates by personal computer level graphics hardware even when terrain data covers a large terrain area having a complex shape, such as, the Earth's surface.

Further embodiments, features, and advantages of the present inventions, as well as the structure and operation of the various embodiments of the present invention, are described in detail below with reference to the accompanying drawings.

### BRIEF DESCRIPTION OF THE FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a block diagram of a distributed terrain management system including a terrain administrator and remote terrain engines according to one embodiment of the present invention.

FIG. 2 is a diagram of a terrain render according to an embodiment of the present invention.

FIG. 3 is a diagram showing a render block manager in FIG. 2 in greater detail.

FIG. 4 is a flowchart of a method for managing terrain rendering information according to an embodiment of the present invention.

FIG. 5 is a diagram illustrating an example spheric 3D terrain topology of virtual world represented by a set of 2D terrain topologies (cube faces) according to an embodiment of the present invention.

FIG. 6 shows an example of a set of 2D terrain topologies (cube faces) laid out in one example arrangement.

FIG. 7A shows the root level of an example data structure of render blocks that represent a set of 2D terrain topologies (cube faces).

FIG. 7B shows an example quad tree having three levels with one or more allocated render blocks.

FIG. 7C illustrates how the terrain sample resolution of the render blocks progressively increases at deeper levels in the quad tree.

FIG. 7D is a pictorial diagram that illustrates how the terrain sample resolution of the render blocks at deeper levels in the quad tree provide a progressively increased level of detail for corresponding areas of a cube face.

FIG. 8 is a diagram of an example render block according to an embodiment of the present invention.

FIG. 9 is a flowchart of a render block allocation algorithm according to an embodiment of the present invention.

FIG. 10 is a flowchart of a routine for filling allocated render blocks according to an embodiment of the present invention.

FIG. 11 is a flowchart of a routine for creating a texture that can be used in the filling allocated render blocks routine of FIG. 10 according to an embodiment of the present invention.

FIG. 12 is a flowchart of a routine for generating triangle list(s) that can be used in the filling allocated render blocks routine of FIG. 10 according to an embodiment of the present invention.

FIGS. 13A and 13B illustrate how a step of adjusting triangulation in FIG. 12 prevents splitting by removing extra vertices at an edge between render blocks at relatively low and high level of detail.

FIGS. 14A and 14B are a flowchart of a render block allocation algorithm that illustrates render block allocation before and after a change in reference point information according to an embodiment of the present invention.

FIGS. 15A, 15B, 15C, 15D, and 15E are diagrams illustrating different stages of render block allocation in one example using the routine of FIGS. 14A and 14B.

FIG. 16 is a flowchart of a render block allocation algorithm that illustrates render block allocation based on a block budget assigned for an entire quad tree according to an embodiment of the present invention

FIG. 17 is a flowchart of a render block allocation algorithm that illustrates render block allocation based on a block budget assigned on a per level of a quad tree according to an embodiment of the present invention.

FIG. 18 is a flowchart of a routine for finding a distance between two points on difference cube faces according to an embodiment of the present invention.

FIGS. 19A, 19B, 19C, and 19D are diagrams illustrating different stages of finding a distance in one example using the routine of FIG. 18.

FIG. 20 is a flowchart of a routine for converting a position in a three-dimensional terrain topology to a position in a set of two-dimensional terrain topologies according to an embodiment of the present invention.

FIG. 21 is a flowchart of a routine for converting a position in a set of two-dimensional terrain topologies to a position in a three-dimensional terrain topology according to an embodiment of the present invention.

FIGS. 22A, 22B, 22C, and 22D are diagrams that illustrate a three-dimensional coordinate space, corner vectors, unit reference vectors, and fractional position information related to the routine of FIG. 21.

FIG. 23 is a flowchart of a routine for converting a position in a three-dimensional terrain topology to a position in a set of two-dimensional terrain topologies according to an embodiment of the present invention.

FIG. 24 is a flowchart of a routine for converting a position in a set of two-dimensional terrain topologies to a position in a three-dimensional terrain topology according to an embodiment of the present invention.

FIG. 25 is a diagram of an example graphics architecture in an implementation of the present invention.

FIG. 26 is a block diagram of a host and graphics subsystem according to an embodiment of the present invention.

FIG. 27 is a block diagram of a computer system according to an embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION Table of Contents

Overview

Terminology

Example Environment

Distributed Terrain Management System

Terrain Renderer

Terrain Data Management

Management of Terrain Rendering Information

Rendering

Example Render Block Manager

Method for Managing Terrain-Rendering Information

Example Cube/Sphere Environment

Data Structure with Six Quad Trees

Example Render Blocks

Render Block Allocation Algorithm

Allocation Criteria

Routine for Finding a Distance Between Points on Different Cube Faces

Filling allocated Render Blocks

Texture Creation

Change of Reference Point Information

Example Render Block Allocation Algorithm Based on Block Budgets Assigned Per Level

Position Conversion

Converting a Position from 3-D to 2-D

Converting a Position from 2D to 3D

Converting a Position in 3D to 2D

Converting a Position from 2D to 3D

Example Graphics Implementations

Example Architecture

Host and Graphics Subsystem

Example Computer System

Conclusion

Overview

The present invention relates to the management of terrain rendering information. A method, system, computer program product, and computer data signal are provided for managing terrain rendering information. A method, system, computer program product, and computer data signal for converting a position in a three-dimensional terrain topology of a virtual world to a position in a set of two-dimensional topologies (and vice versa) are also provided.

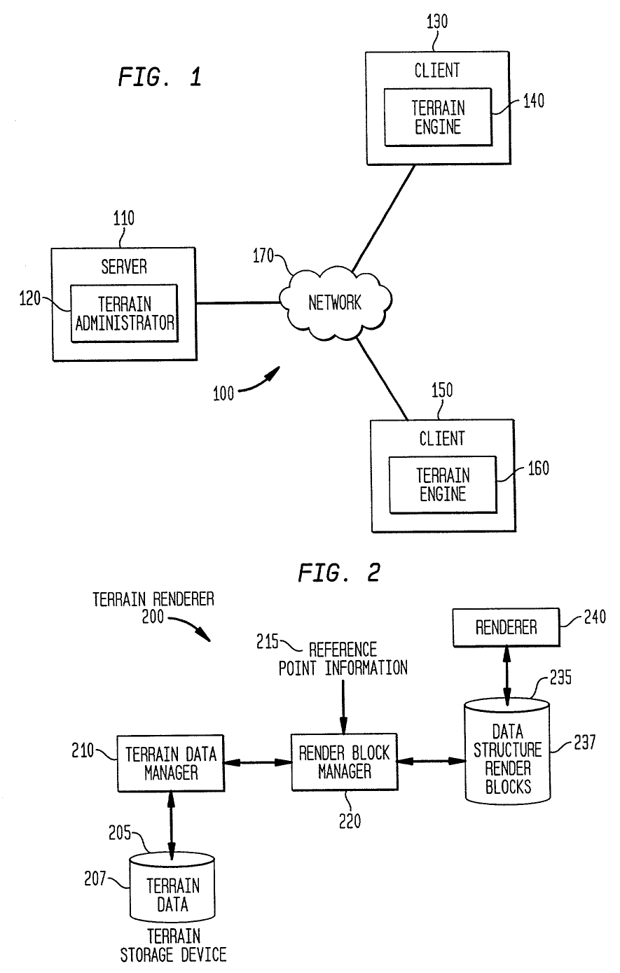

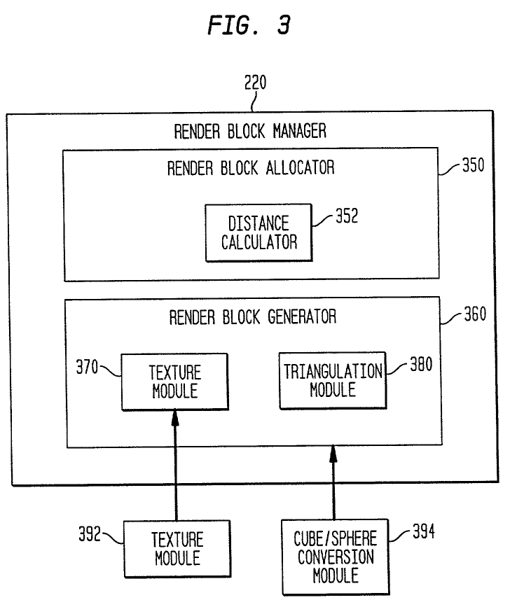

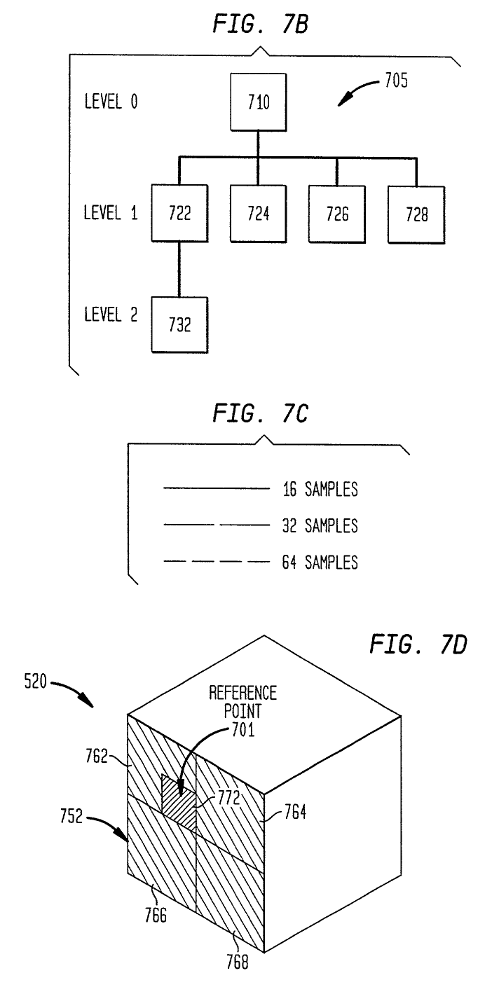

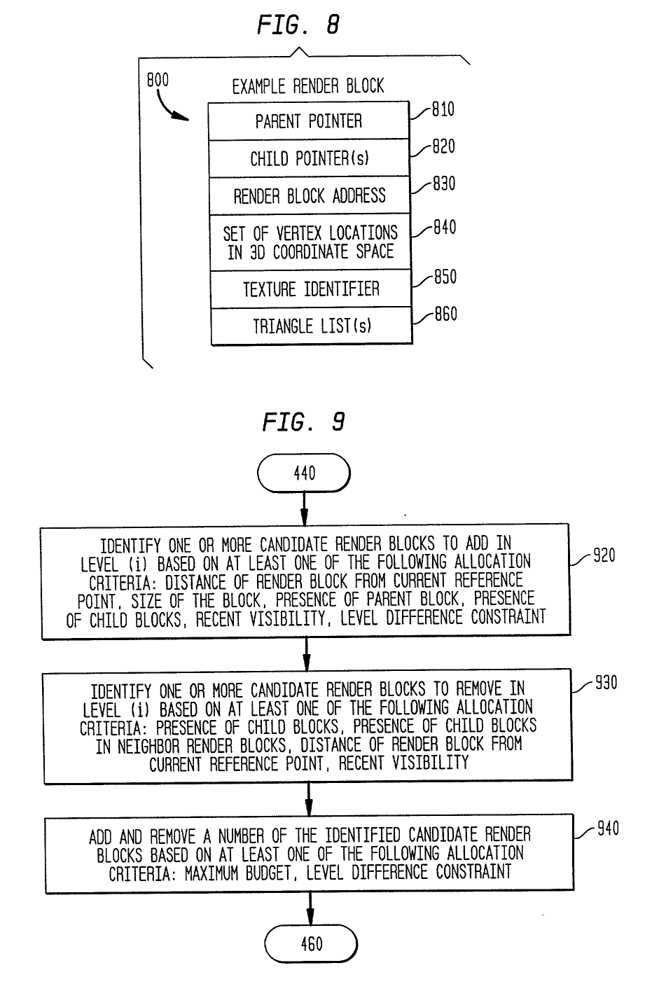

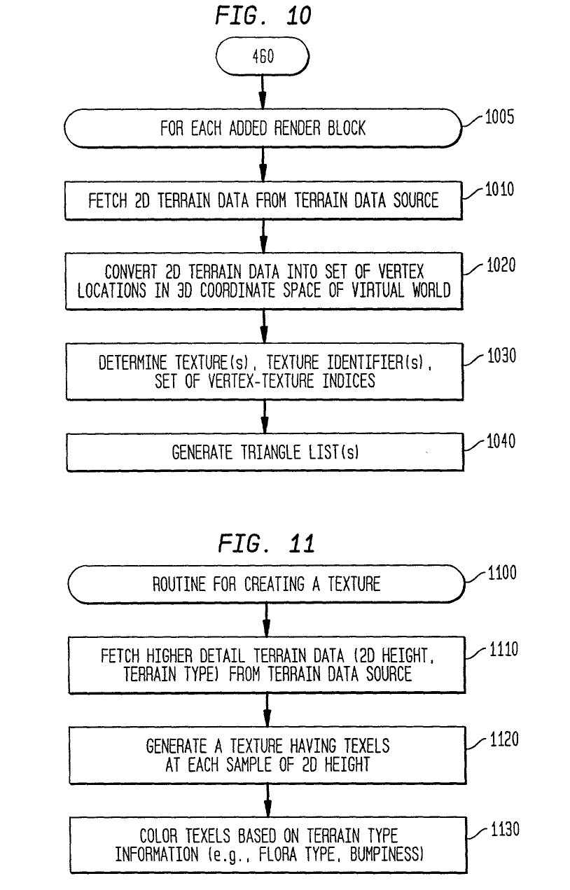

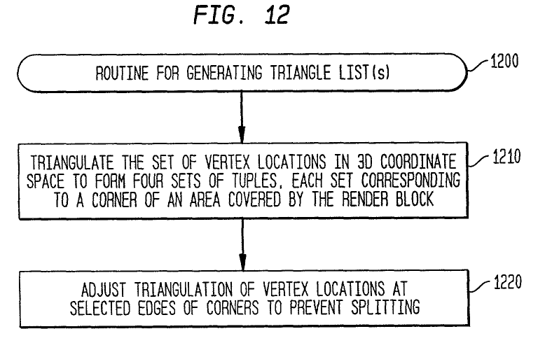

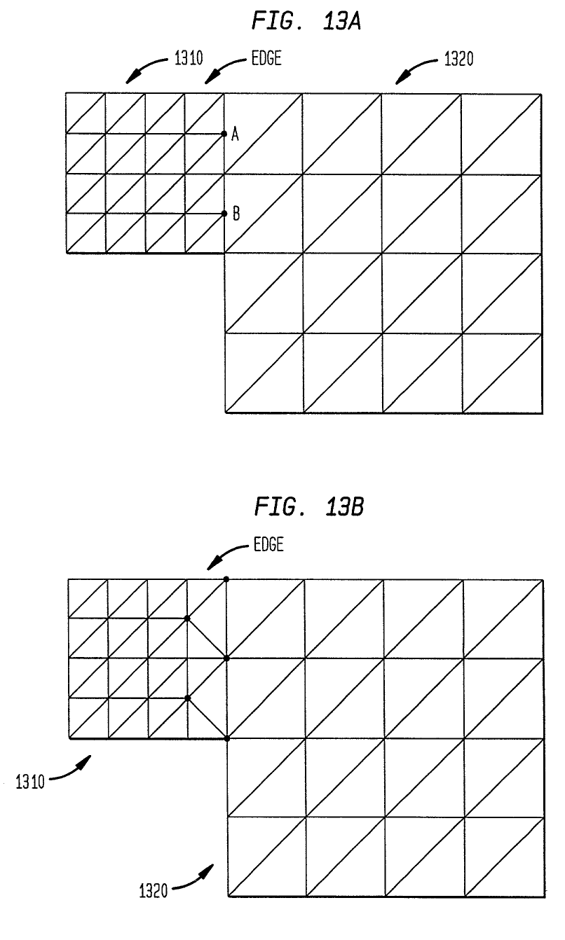

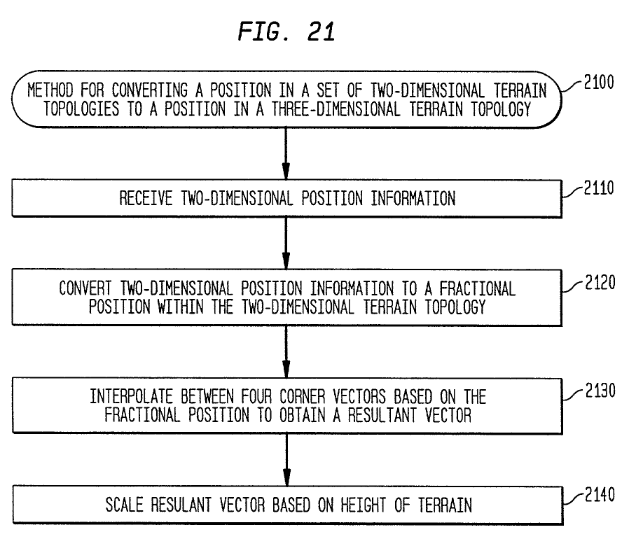

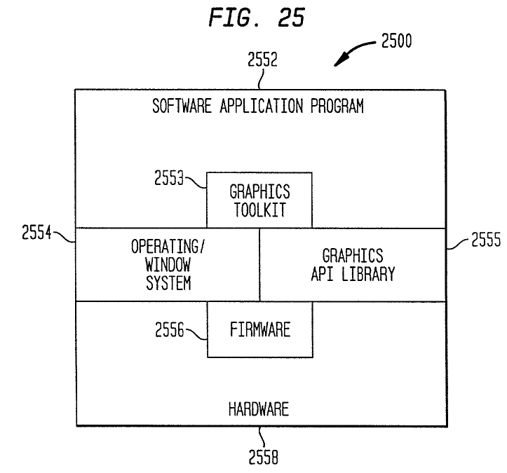

In the following description, terminology and example environments of the invention are described. First, a distributed terrain management environment having a terrain administrator and remote terrain engines in which the invention can be used is described with respect to FIG. 1. A system and method for managing terrain rendering information according to an embodiment of the present invention is then described with respect to FIGS. 2-4. To further explain the invention, examples are described including: a spheric 3D terrain topology of virtual world represented by a set of 2D terrain topologies (FIG. 5), a set of 2D terrain topologies (cube faces) laid out in one arrangement (FIG. 6), information related to a data structure of quad trees representative of cube faces (FIGS. 7A-7D), and a render block (FIG. 8). Flowcharts and diagrams related to render block allocation, texture creation, and triangulation, according to embodiments of the present invention and features therein, are next described with respect to FIGS. 9-19. Flowcharts and diagrams related to position conversion, according to embodiments of the present invention, are described with respect to FIGS. 20-24. Finally, example computer graphics systems and architectures in which the invention can be used is described with respect to FIGS. 25-27.

Terminology

The term “distributed terrain management system” is meant to refer broadly to any system that couples a terrain administrator and at least one terrain engine. A distributed terrain management system can include, but is not limited to, a centralized host/terminals arrangement, a client/server arrangement, distributed multiple clients and multiple servers arrangement, or peer-to-peer arrangement.

The term “sphere” is used broadly to refer to any perfect or near perfect sphere, ellipse, spheroid, or similarly shaped object. “Sphere” also includes degenerate shapes that are of similar form.

The term “cube” is used broadly to refer to any perfect or near perfect cube, rectangular prism, or similarly shaped object. “Cube” also includes degenerate shapes that are of similar form.

The term “interactive rate” means any rate acceptable to a user including, but not limited to, a rate of every several frames, every frame, or faster than a second.

“Texture” means an array of texels (also called texture samples). “Texel” means a texture element, intensity value, or color value. Texture is applied in a texture mapping process to add surface detail to geometry being rendered. “Multiple texturing” refers to a texture mapping process where texture is drawn from multiple textures to add surface detail to geometry being rendered.

Example Environment

Embodiments of the present invention are described below with respect to example distributed terrain management and computer graphics environments.

These example environments, however, are illustrative and not necessarily intended to limit embodiments of the present invention. For example, the present invention can be used with any terrain data source on a stand-alone computer or a networked computer including, but not limited to, a terrain engine that allows terrain data covering the Earth's surface to be rendered, managed, updated, and/or administered at real-time interactive frame rates by consumer-level graphics hardware as described with respect to FIG. 1. In other embodiments, terrain data is simply obtained from user input, memory, a file or any other type of terrain data source.

Distributed Terrain Management System

FIG. 1 is a block diagram of a distributed terrain management system 100.

Distributed terrain management system 100 includes a server 110 coupled over network 170 to multiple clients 130,150. Network 170 can be any type of computer network or combination of networks including, but not limited to, circuit switched and/or packet switched networks. In one example, network 170 includes the Internet. Server 110 further includes a remote terrain administrator 120. Client 130 includes a terrain engine 140. Client 150 includes a terrain engine 160. Only one terrain administrator 120 and two clients 130,150 are shown for clarity. In general, any number of clients and servers can be included in distributed terrain management system 100.

Terrain administrator 120 is responsible for remotely monitoring and administrating terrain data across the distributed terrain network system 100.

Terrain administrator 120 can provide edits or updates to terrain data in terrain engines 140,160. Terrain administrator 120 can also perform administrative and management functions, as would be apparent to a person skilled in the art given this description.

Terrain engine 140 and terrain engine 160 are respective client-side terrain engines according to the present invention. Client 130 can provide edits or updates to terrain data associated with a particular user. Likewise, client 150 can provide updates to, or edits to terrain data associated with another user.

Any conventional communication protocols can be used to support communication between terrain administrator 120 and terrain engines 140, 160.

For example, a TCP/IP suite can be used to establish links and transport data. A World Wide Web-based application layer and browser (and Web server) can also be used to further facilitate communication between end users at clients 130, 150 and an administrator at server 110. However, these examples are illustrative. The present invention is not intended to be limited to a specific communication protocol or application, and other proprietary or non-proprietary network communication protocols and applications can be used.

A variety of information can be provided to a terrain 140, 160 as a user navigates. Terrain data can be progressively streamed to a user as a user enters a new area, so that he or she gets a timely view of the region's terrain. For example, as the user moves around the Earth he or she may receive terrain information that is added to a terrain database, and used to synthesize data into the local terrain data cache. A local disk is considered a cache of the network, and operates similarly to a file cache in a web browser. Consistency can also be maintained with data in the terrain server 110. A window of delay is set (for example to a 24 hour or so window) before requiring a time stamp check with the server 110 (and terrain administrator 120) to check for updates.

Terrain engines 140 and 160 each include a computer graphics system for generating computer graphics displays and animation of a scene. Computer graphics systems render all kinds of objects including terrain for screen display and animation. An object is modeled in object space by a set of primitives (also called graphics primitives). Examples of primitives include, but are not limited to, triangles, quads, polygons, lines, tetrahedra, curved surface, and bit-map images. Each primitive includes one or more vertices that define the primitive (or a fragment) in terms of position, color, depth, texture, and/or other information helpful for rendering. Examples of computer graphics systems and a computer system that can be used in implementations of the present invention are discussed further below with respect to FIGS. 25-27.

According to the present invention, each terrain engine 140 and 160 further includes a terrain rendering information management system as described below.

Terrain Renderer

FIG. 2 is a diagram of a terrain renderer 200 according to an embodiment of the present invention. Terrain renderer 200 includes a terrain storage device 205, terrain data manager 210, render block manager 220, terrain-rendering information storage device 235, and renderer 240. Terrain renderer 200 then includes three main operations: terrain data management, management of terrain rendering information, and rendering based on the terrain rendering information. Terrain data management is handled by terrain data manager 210. Management of terrain rendering information is handled by render block manager 220. Rendering is handled primarily by renderer 240. Each of these operations is described further below.

Terrain Data Management

Terrain storage device 205 stores terrain data 207. Terrain storage device 205 can be one or more storage devices that store digital data including, but not limited to, any type of memory, cache memory, database, disk storage device, tape storage device, and/or file system. Terrain data 207 can be any type of terrain data including, but not limited to a height field. In one example, terrain data 207 comprises height field data, terrain type data, and delta data as described in the commonly-owned, co-pending application entitled “Synthetic Terrain Generation Including Fractal Terrain Generation and Terrain-Type Data Generation,” Application Ser. No. 09/560,886, filed on Apr. 28, 2000 by W. Harvey, et al., which is incorporated in its entirety herein by reference.

Terrain data manager 210 is coupled between terrain storage device 205 and render block manager 220. Terrain data manager 210 accesses terrain storage device 205 to retrieve terrain data 207. Terrain data manager 210 also accesses terrain storage device 205 to add or edit terrain data 207. Terrain data manager 210 receives requests for terrain data from render block manager 220 and fulfills the requests by returning requested terrain data.

In one embodiment, terrain data management as described in by B. Werther et al., Method, System, and Computer Program Product for Managing, Rendering and/or Administering Terrain Data, Application Ser. No. 09/560,564, filed Apr. 28, 2000 (incorporated in its entirety herein by reference). This terrain data management includes a local file system and network interface coupled to terrain database. A terrain data manager is coupled to the terrain database and includes a fractal terrain generator. The terrain data manager further stores a portion of terrain data in a terrain data cache for quicker access to fulfill terrain data requests. The terrain data itself is stored in a hierarchy of quad trees corresponding to cube faces.

Management of Terrain Rendering Information

Render block manager 220 is coupled to terrain-rendering information storage device 235. Terrain-rendering information storage device 235 can be one or more storage devices that store digital data including, but not limited to, any type of memory, cache memory, database, disk storage device, tape storage device, and/or file system.

Terrain-rendering information storage device 235 stores a data structure 237. The data structure 237 includes allocated render blocks. Each of the allocated render blocks in the data structure 237 includes graphics data for terrain to be rendered. The graphics data can include terrain primitives and texture information. According to the present invention, render block manager 220 manages the allocation of render blocks in the data structure 237 based on current reference point information 215. The operation of render block manager 220, and in particular, the management of the allocation of render blocks in the data structure 237, is described in further detail below. Render block manager 220 can be implemented in software, firmware, hardware, or any combination thereof.

Rendering

Renderer 240 is coupled to terrain-rendering information storage device 235. Renderer 240 renders scenes based on the graphics data in data structure 237. In one example, renderer 240 renders a scene including terrain based on the primitives and texture information stored in allocated render blocks in the data structure 237. Renderer 240 can be any conventional computer graphics renderer, including but not limited to an OpenGL, Direct X, Renderman, NVidea, or other rendering system. Contents of data structure 237 and its allocated render blocks are further described below with respect to example embodiments.

Example Render Block Manager

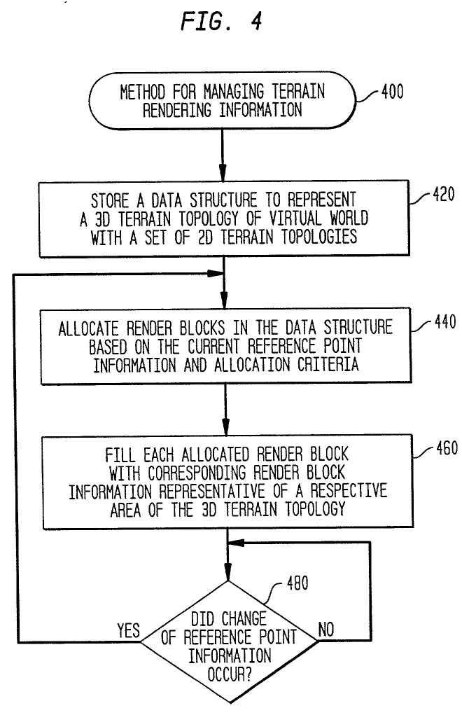

FIG. 3 is a diagram of an example render block manager 220, according to an embodiment of the present invention. Render block manager 220 includes render block allocator 350 and render block generator 360. Render block allocator 350 includes a distance calculator 352. Render block generator 360 includes texture module 370 and triangulation module 380. Texture module 370 is coupled to a texture creator 392. Render block generator 360 is also coupled to a cube/sphere conversion module 394.

In one embodiment, render block manager 220 manages the allocation of render blocks in data structure 237. Render block manager 220 manages the allocation of render blocks such that render blocks are maintained in data structure 237 which have terrain primitive data covering an area based on current reference point information 215. Reference point information 215 is any information that identifies a reference point. A reference point can include, but is not limited to, a camera point, an eye point, or any other reference point defined with respect to a scene being rendered.

In one example, render block manager 220 manages the allocation of render blocks in data structure 237 based on at least one allocation criterion. Such allocation criteria can include, but is not limited to, the following: distance of a candidate render block from current reference point information, size of a candidate render block, recent visibility of a candidate render block, presence of a parent render block, presence of a child render block for the candidate render block, presence of a child render block for a neighbor render block of the candidate render block, a level difference constraint, and a maximum budget of render blocks. The present invention is not necessarily limited to specific allocation criteria. In general, the present invention can be used with any one or more of the allocation criteria, as will be apparent to a person skilled in the art given this description.

The selection of allocation criteria depends upon a particular application and data structure chosen. In one embodiment, data structure 237 comprises six quad trees. Each quad tree has one or more levels. Render block manager 220 then manages the allocation of the render blocks in the six quad trees of the data structure. Render block manager 220 then manages the allocation of render blocks based on an allocation criteria that includes a budget of render blocks based on a maximum number of render blocks allowed per level of each quad tree. In another embodiment, render block manager 220 manages the allocation of render blocks in the quad tree based on a budget of render blocks based on a maximum number of render blocks allowed in each quad tree. Render block manager 220 can manage the allocation of render blocks in the quad tree on a per-quad-tree budget basis or a per-quad-tree-level budget basis.

In one embodiment, render block manager 220 manages the allocation of render blocks in data structure 237 based on the distance of a candidate render block from current reference point information allocation criteria. In this way, as a reference point such as a camera point moves, render blocks are allocated to keep terrain primitive data at higher level of detail in data structure 237 at reference point 215.

In one embodiment, render block allocator 350 identifies render blocks to be added or removed from data structure 237. Render block allocator 350 identifies render blocks to be added or removed based on current reference point information 215 and one or more allocation criteria. Render block generator 360 then fills information in each render block that is determined to be added to data structure 237. In one embodiment, the allocation criteria includes a distance of a candidate render block from current reference point information 215. Distance calculator 352 calculates a distance of a candidate render block from current reference point information 215. Any technique for calculating distance can be used according to the present invention. One embodiment for calculating a distance between first and second points on different cube faces is described below with respect to routine 1800. Distance calculator 352 determines a distance between two points on the same or different cube faces. A routine for finding a distance between positions of first and second points on different cube faces is described below with respect to routine 1800.

Render block generator 360 fills information in each render block to be added to data structure 357. In one embodiment, texture module 370 identifies a texture for each allocated render block. In one example, texture module 370 creates a texture identifier that points to a texture to be applied during rendering to terrain data corresponding to an allocated render block. One or more textures can be identified. For example, if hardware is available to support multiple texture rendering, then texture module 370 can identify more than one texture.

In this case, texture module 370 would output multiple texture identifiers that point to multiple textures to be used in rendering.

Texture module 370 can select from one or more pre-stored textures. Alternatively, a set of available textures can be modified in real time. In one embodiment, a texture creator 392 automatically creates textures. For example, texture 392 can create a texture corresponding to an allocated render block. One routine 1100 for creating a texture according to an embodiment of the invention is described further below. In one example, texture creator 392 fetches terrain data that has samples at a higher level of detail than primitive data in a corresponding render block. Texture creator 392 then generates a texture having texels at the samples of the fetched terrain data and colors the texel based on terrain type information. For example, terrain type information can include flora type and/or bumpiness information.

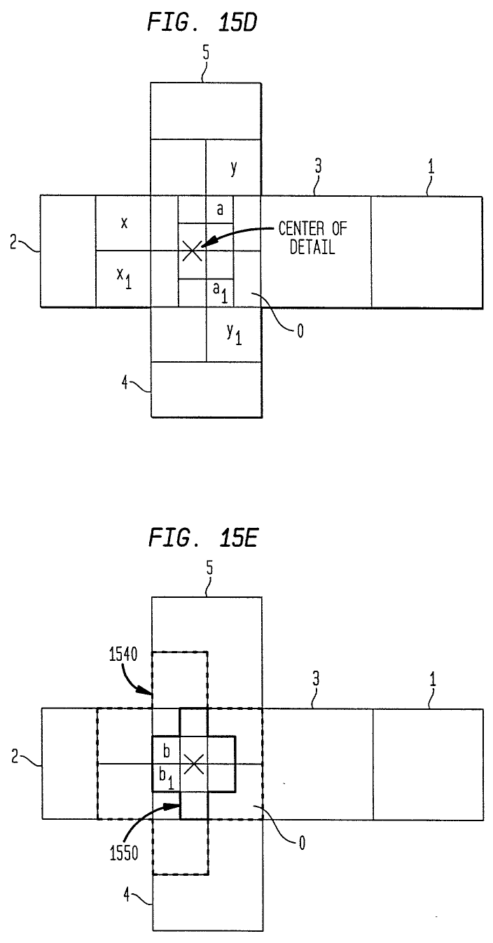

Triangulation module 380 triangulates a set of vertex locations in three-dimensional coordinate space to form sets of tuples. Each tuple then defines a triangle to be rendered. The present invention is not limited to triangles, and as will be apparent to a person skilled in the art given this description, other types of primitive data can be used such as quads, polygons, lines, segments, or any other primitive. According to a further feature of the present invention, triangulation module 380 adjusts the triangulation to avoid splitting. In particular, triangulation module 380 adjusts the triangulation of vertex locations at selected edges of corners to avoid splitting. For example, triangulation module 380 removes extra vertex locations at edges which are a boundary between render blocks having relatively low and high level of detail. The operation of triangulation module 380 to generate triangle lists is described further with respect to routine 1200 and examples in FIGS. 13A and 13B.

Cube/sphere conversion module 394 is provided to convert position information between different terrain topologies. In one embodiment, a cube/sphere conversion module converts a position in a three-dimensional terrain topology of a virtual world to a position in a set of two-dimensional topologies. In addition, cube/sphere conversion module also converts a position in a set of two-dimensional topologies to a position in a three-dimensional terrain topology of a virtual world. The operation of a cube/sphere conversion module in converting position information is described further with respect to different embodiments and methods shown in FIGS. 20-24.

Render block manager 220 and individual component modules shown in FIG. 3 can be implemented in software, firmware, hardware, or any combination thereof.

Method for Managing Terrain-rendering Information

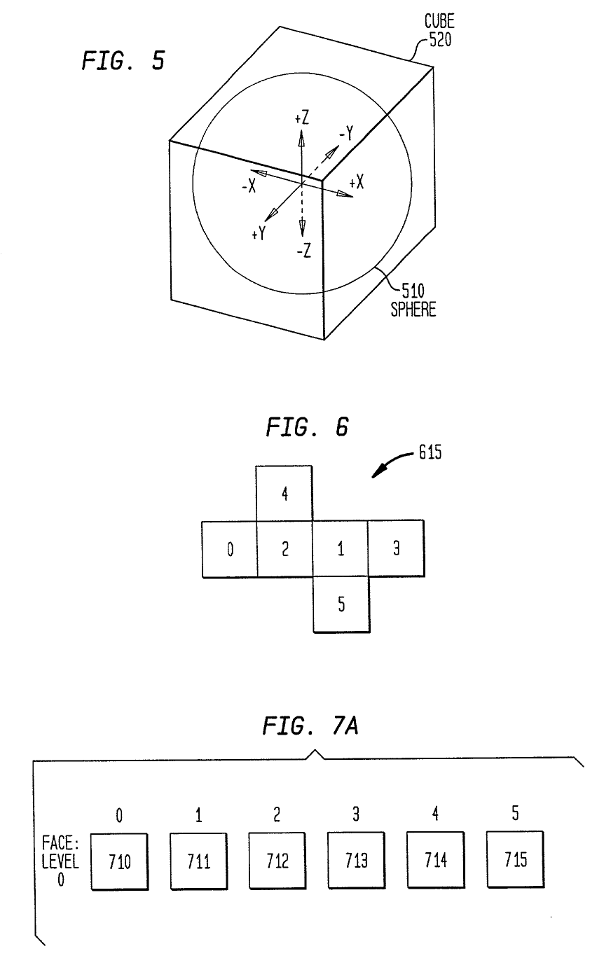

FIG. 4 shows a method for managing terrain-rendering information 400 according to an embodiment of the present invention (steps 420-480). For brevity, method 400 is described with respect to terrain renderer 200 and in particular to render block manager 220. Method 400 is not necessarily limited to the structure of terrain renderer 200.

In step 420, a data structure is stored that represents a three-dimensional terrain topology of a virtual world with a set of two-dimensional terrain topologies. For example, render block manager 220 stores data structure 237 in terrain rendering information storage device 235.

In step 440, render blocks are allocated in the stored data structure. The render blocks are allocated based on a current reference point information and allocation criteria. For example, render block manager 220 allocates the render block in data structure 237 based on a current reference point information and allocation criteria.

In step 460, render block manager 220 fills each allocated render block with corresponding render block information. The render block information is representative of a respective area of the three-dimensional terrain topology.

Render block information includes at least terrain data. In one embodiment, terrain data includes four triangle lists covering quadrants of an area associated with a particular render block. Render block information can further include a texture identifier, parent pointer, child pointers, and a set of vertex locations. Render block manager 220 processes appropriate terrain data 207 for each new allocated render block retrieved from terrain storage device 205.

In step 480, render block manager 220 checks to determine whether a current reference-point information has changed. If the reference-point information has not changed, then the data structure with allocated render blocks is current and no further changes are made. If the reference point information has changed, then control returns to step 440. In this case then, steps 440 and 460 are repeated based on the new or changed reference point information.

The operation of each of these steps 420-480 is described further below with respect to specific embodiments (FIGS. 5, 6, 7A-7D, 8-12, 13A, 13B, 14A, 14B, 15A-15E, 16-18, 19A-19C, and 20-27).

Example Cube/Sphere Environment

In one embodiment of the present invention, a three-dimensional terrain topology of a virtual world is represented by a set of two-dimensional topologies. In general, general terrain calculations can be performed more simply and faster on a two-dimensional topology than a three-dimensional topology. FIG. 5 is a diagram that illustrates an example three-dimensional topology of a virtual world defined with respect to a sphere 510. A set of two-dimensional topologies defines cube faces of cube 520. Terrain defined in a coordinate space of the cube faces of cube 520 then approximates terrain defined in a coordinate space of sphere 510.

Cube 520 has six faces which can be arranged in any number of layouts. FIG. 6 shows one example layout 615. In layout 615, cube faces 0-5 are arranged such that cube faces 0, 2, 1, 3 are arranged in a row side-by-side with cube face 4 adjoining cube face 2, and cube face 5 adjoining cube face 1. Cube face 4 is also adjoining cube face 2 on a side opposite the side where cube face 5 adjoins cube face 1. Layout 615 is illustrative and not intended to limit the present invention.

Data Structure with Six Quad Trees

In one embodiment, data structure 237 comprises a data structure having six quad trees at a root level. The six quad trees represent six cube faces of cube 520. Each cube face is further represented by a respective quad tree of zero or more allocated render blocks.

FIG. 7A shows an example of a root level (level 0) having six allocated render blocks 710, 711, 712, 713, 714,715 corresponding to six respective cube faces (faces 0-5). FIG. 7B shows an example quad tree 705 having three levels (levels 0, 1, 2) with one or more allocated render blocks (710, 722, 724, 726, 728, 732). In particular, quad tree 705 has one allocated render block 710 in level 0. Four allocated render blocks 722-728 are present in level 1. One allocated render block 732 is present in level 2. Quad tree 705 is illustrative and not intended to limit the present invention. A greater or smaller number of levels can be used. A greater or smaller number of render blocks can be allocated.

Each of the allocated render blocks represents an area of terrain topology. The level of detail increases progressively in deeper levels in the quad tree. In other words, the resolution or number of samples of terrain data increases progressively at deeper levels in the quad tree. For example, as shown in FIG. 7C, the highest level, level 0, or the root level, may have 16 samples along one dimension. The next level, level 1, may then have 32 samples along a dimension. The next successive level (level 2) would then have 64 samples along a dimension. In this way, each render block has terrain data at a progressively increased resolution. Render block manager 220 then manages the allocation of the render blocks in different levels to keep an appropriate higher level of detail near a current reference point.

FIG. 7D is a pictorial diagram that illustrates how the terrain sample resolution of allocated render blocks at deeper levels in a quad tree provide a progressively increased level of detail for terrain corresponding to areas of a cube face. For example, quad tree 705 can be used to contain terrain rendering information for a current reference point 701. In this example, render block 710 in root level 0 is allocated which corresponds to one face 752 of cube 520. Next, allocated render blocks 722, 724, 726 and 728 correspond to areas 762, 764, 766 and 768, respectively, of the cube face 752. These four areas covered by these render blocks 722, 724, 726 and 728 are also referred to herein as “quadrants” of render block 710 Similarly, allocated render block 732 of level 2 corresponds to area 772 that includes the reference point 701. In this way, terrain rendering information is managed efficiently and simply using quad trees in a cube topology rather than a complex, three-dimensional, spheric terrain topology. Terrain can be represented with high levels of resolution by using deeper quad trees and more rendering blocks at deeper levels of quad trees.

Example Render Blocks

FIG. 8 shows a render block 800 according to an embodiment of the present invention. Render block 800 includes a parent pointer 810, child pointers 820, a render block two-dimensional address 830, a set of vertex locations in a three-dimensional coordinate space 840, one or more texture identifiers 850, and one or more triangle lists 860. In the example of a quad tree, parent pointer 810 points to a parent render block in the level immediately above. Child pointers 820 point to zero or more allocated child render blocks in the level immediately below (i.e, the next level deep in the quad tree). Render block address 830 includes information to identify a position of the render block in a two-dimensional terrain topology, such as, a position within a particular cube face of a cube topology. In one example, render block address 830 includes a cube face identifier, a block reference point address (x,y), and a quad tree level identifier. The cube face identifier identifies a particular cube face (0-5) within a cube topology. The block reference point address (x,y) identifies an address of the render block within a two-dimensional coordinate space of the cube face. The quad tree level identifier identifies which level of the quad tree the render block is associated, such as, level 0, 1, 2, etc.

The set of vertex locations 840 in three-dimensional coordinate space is a set of three-dimensional points. This set of three-dimensional points is also known as “raw 3D data.” Such raw 3D data represents the samples of three-dimensional terrain data associated with the render block.

Texture identifier 850 identifies a texture or multiple textures to be applied during rendering. Different texturing schemes are possible. In one embodiment, texture identifier 850 is a pointer points to a texture. In another embodiment, texture identifier 850 contains texture type identifier information (flora, bumpiness). Flora type information identifies terrain characteristics related to ground cover, such as, forest, grass, sand, rock, etc. Bumpiness information identifies terrain information related to height, such as whether the terrain is a flat, coastal area, foothill area, rocky mountain range, or Himalaya mountain range. In one implementation, terrain type information can be a two-byte field identifying flora type and bumpiness values.

One or more triangle lists 860 correspond to the triangle primitive data in the respective allocated render block. In one example, each allocated render block is considered to represent a square area of a two-dimensional terrain topology on a cube face. Four triangle lists are included. The four triangle lists correspond to lists of triangles representing quadrants of a square area associated with the render block.

Render Block Allocation Algorithm

FIG. 9 is a flowchart of a render block allocation algorithm according to an embodiment of the present invention. In particular, FIG. 9 shows an example embodiment for carrying out step 440 of FIG. 4 (steps 920-940). In step 920, one or more candidate render blocks are identified to add to any of the quad trees. Render blocks are identified as candidates for addition to a quad tree based on at least one of the following allocation criteria: distance of render block from current reference point, size of the block, presence of parent block, presence of child blocks, recent visibility, and a level difference constraint (step 920).

In step 930, one or more candidate render blocks to remove from any of the quad trees are identified. Candidate render blocks to remove are identified based on at least one of the following allocation criteria: presence of child blocks, presence of child blocks and neighbor render blocks, distance of render block from current reference point, and recent visibility. In step 940, a number of the identified render blocks are then added or removed. The number of identified candidate render blocks which are added and removed is also determined based on allocation criteria. For example, the number of identified render blocks to add or remove can be based on a maximum budget of blocks, and/or a level difference constraint.

Steps 920-940 can be performed one or more times at each level until an optimum allocation of render blocks is allocated. An optimum allocation for example may be an allocation where the blocks already allocated (added) at that level in the quad trees are equal to or more important based on allocation criteria than any candidate render blocks. Steps 920-940 are repeated for each of the levels of the quad trees. In one example, steps 920-940 are carried out at a root level of the quad trees and the proceeds to progressively deeper levels until an optimum allocation of render blocks is achieved throughout the levels of all of the quad trees. When the bottom level is reached and processed, control returns to step 460.

Allocation Criteria

As described above, allocation criteria are used to allocate render blocks. Allocation criteria plays a role in determining the identification of candidate render blocks to add (step 920), identification of candidate render blocks to remove (step 930), and adding and removing a number of the identified candidate render blocks (step 940). Each of the allocation criterion are now described.

Distance

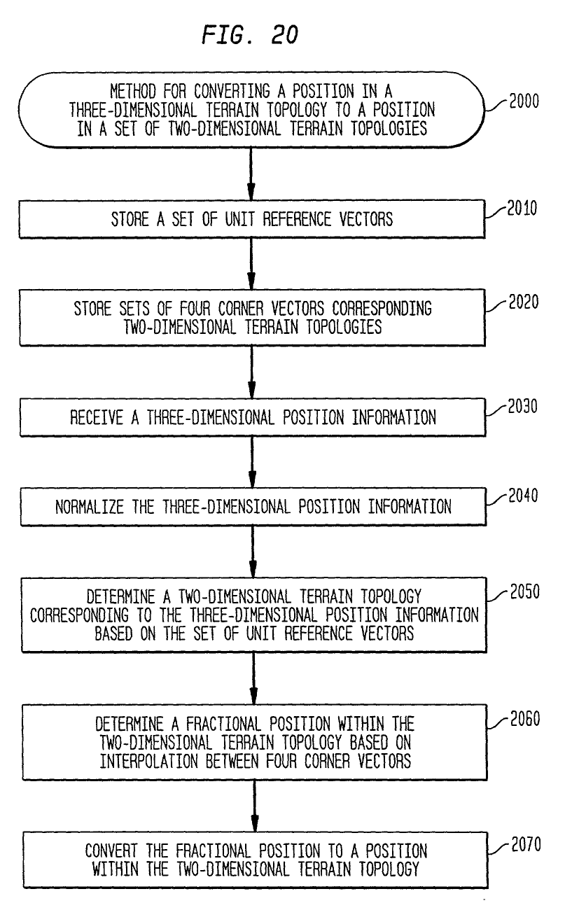

Distance of render block from current reference point refers to the distance of a render block from a current reference point 215. Note, this distance needs to be determined between two points in the same coordinate space. For example, if a cube topology is used, then reference point information 215 is provided which defines a position within a cube face. A candidate render block may lie on the same cube face as the reference point, or on a different cube face. If the candidate render block lies on the same cube face, then the distance calculated is the distance between the render block address and the reference point. For example, as shown in FIG. 19A, case 1, the distance calculated between a reference point x and a render block address c is simply a distance d. This distance is calculated according to conventional distance determination techniques, since the two points are in the same coordinate space.

In case 2 of FIG. 19A, a candidate render block has a position on a different cube face than the reference point information 215. Since the cube is represented by a layout of cube faces in a two-dimensional coordinate space, points on different cube faces may appear to be farther away than an actual distance in a cube topology. FIGS. 19B and 19C are diagrams that illustrate how this can occur. FIG. 19B shows a layout of cube faces 615. Point a corresponds to reference point information 215 (denoted by an X) and lies in face 0. Point b corresponds to a candidate render block and lies in cube face 4. Merely calculating a distance between the two points a and b would result in a larger distance d'than the actual distance across a cube topology. To determine the correct distance, the addresses at points a and b need to be converted into the same coordinate space of a common cube face. In this example, cube face 4 adjoins cube face 0 along a common edge. The correct distance d″ is then the sum of the distances between the points to the common edge. For example, as shown in FIG. 19C, the distance d″ equals the sum of distance x₁ from the point a on cube face 0 to the common edge and the distance x₂ from the common edge to point b on cube face 4.

Routine for Finding a Distance Between Points on Different Cube Faces

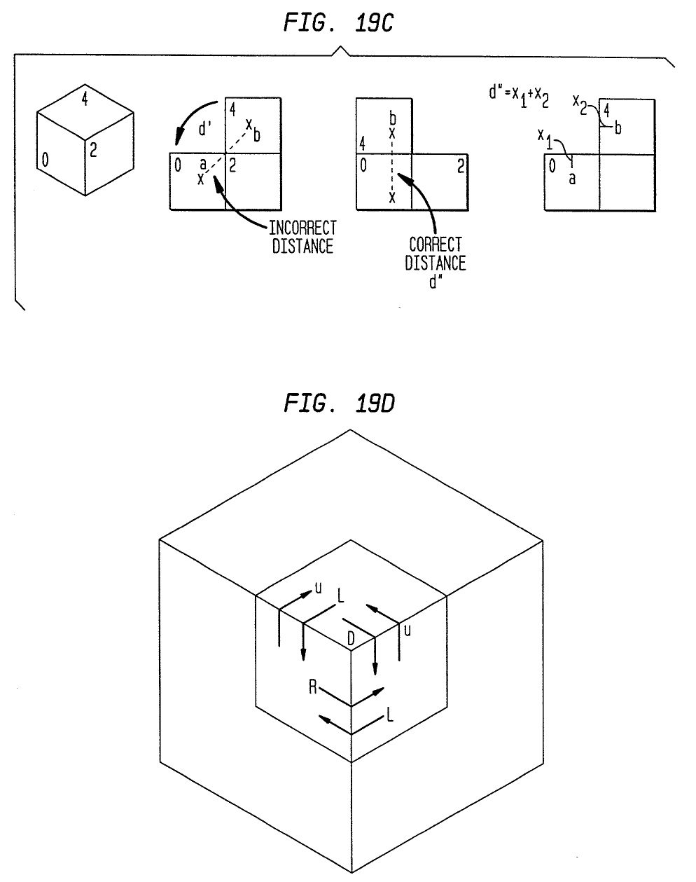

FIG. 18 is a diagram of a routine 1800 for finding a distance between positions of first and second points on different cube faces (steps 1810-1830). In step 1810, a relationship is determined between cube faces. This relationship is determined based on the layout of cube faces in a two-dimensional coordinate space. In step 1820, the second point position is converted to the same coordinate space as the first point position. This conversion is based on the determined relationship of the cube faces, that is, whether the cube faces have a common edge or are on opposite side of the cube. In one example, a set of directions up, down, right and left are used to define orientations of each cube face with respect to other cube faces as shown in FIG. 19D. The set of directions then can be used to determine the appropriate conversion of the second point to the coordinate space of the first point.

In step 1830, the distance is calculated between the first point position and the converted second point position. Any conventional distance calculation technique can be used, since the first point position and converted second point position are in the same coordinate space.

In one embodiment, distance calculator 352 performs the distance calculation between points on the same or different cube faces. Distance calculator 352 can carry out routine 1800 for different cube faces.

Filling Allocated Render Blocks

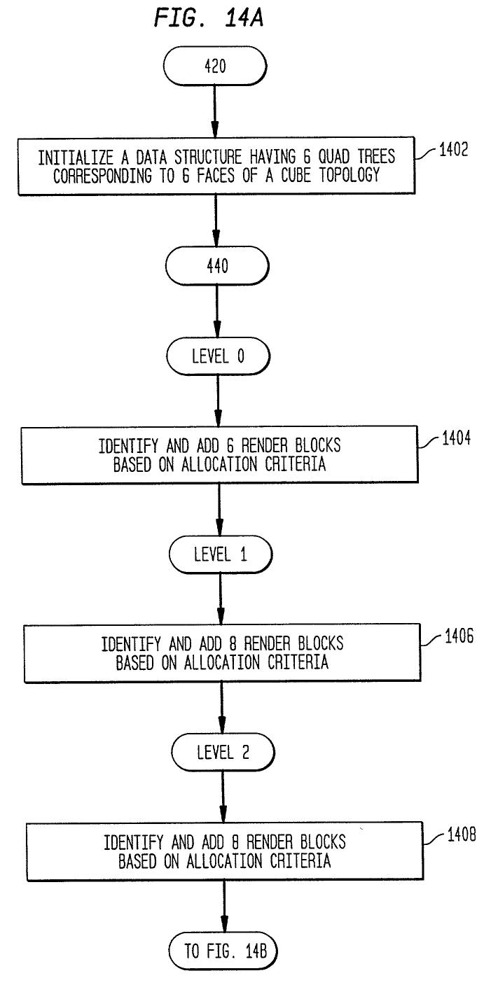

FIG. 10 is a flowchart of a routine for filling allocated render blocks according to an embodiment of the present invention. FIG. 10 is one embodiment for carrying out step 460 of FIG. 4. For convenience, the operation of FIG. 10 will be described with respect to the example render block 800 in FIG. 8. The routine of FIG. 10 and step 460, however, is not intended to be limited to this example render block 800. Control begins at step 1005. For each added render block, steps 1010-1040 are performed.

In step 1010, two-dimensional terrain data is fetched from a terrain data source. For example, render block manager 220 can request two-dimensional terrain data of terrain data manager 210. Terrain data manager 210 will then fetch two-dimensional terrain data 207 from terrain data storage device 205. The two-dimensional terrain data which is fetched corresponds to two-dimensional terrain data at the address of the render block to be added. For example, this render block two-dimensional address can be a render block two-dimensional address 830 as described with respect to FIG. 8, which includes a cube-face identifier, block reference point address (x,y), and quad tree level identifier. Terrain data manager 210 then traverses a quad tree of terrain data 207 to access the two-dimensional terrain data. The cube face identifier identifies the proper quad tree, and the quad tree level identifier identifies the level on the quad tree. The block reference point address (x,y) identifies the two-dimensional terrain data in that cube face at that quad tree level.

In one embodiment, the fetched, two-dimensional terrain data includes a grid of two-dimensional height values and texture identifiers. The texture identifiers identify one or more textures associated with a grid of two-dimensional height values.

In one embodiment, the fetched two-dimensional terrain data includes a grid of two-dimensional height values and terrain type information. For example, the terrain type information can be a field that identifies characteristics of the terrain such as the type of terrain ground cover and height properties. In one embodiment, the terrain type information is referred to as flora type and bumpiness type.

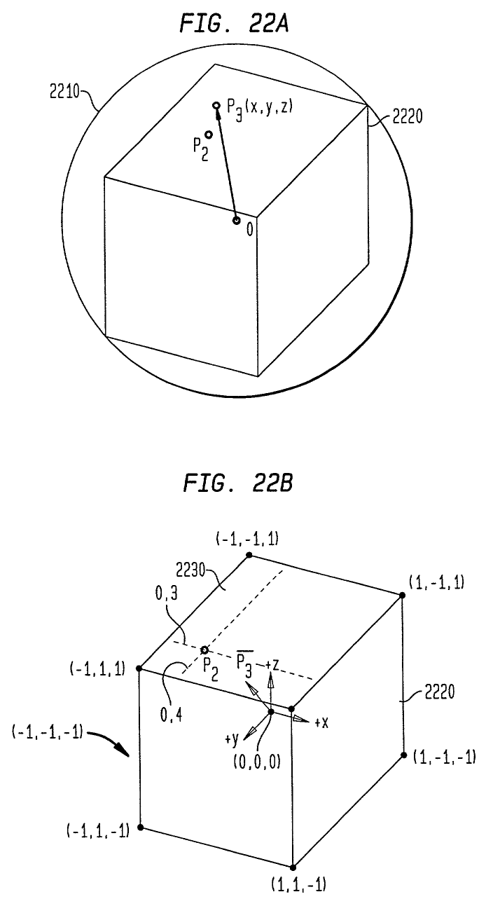

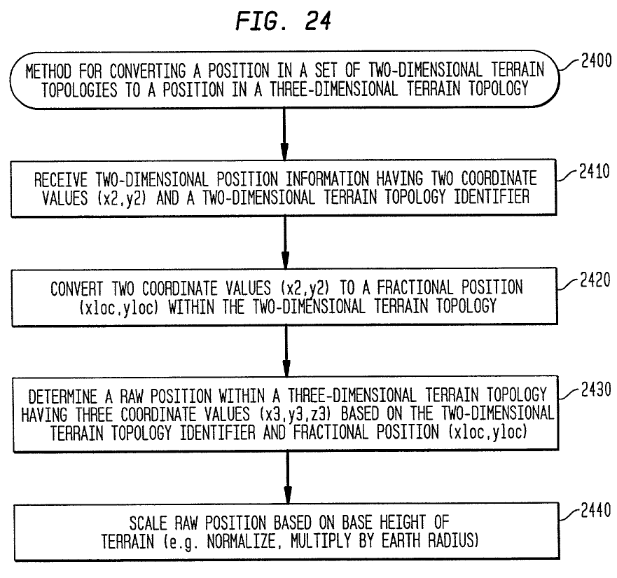

In step 1020, the two-dimensional terrain data is converted into a set of vertex locations in three-dimensional coordinate space of a virtual world. The two-dimensional terrain datafetched in step 1010 consists of a grid of terrain data samples. The grid of terrain data samples have height-field values representing heights in a two-dimensional cube face. In step 1020, the conversion of these two-dimensional heights results in a set of three-dimensional vertex locations (also called raw three-dimensional data). Any technique for converting a position in the two-dimensional terrain topology to a position in a three-dimensional terrain topology can be used, as can be apparent to a person skilled in the art given this description. One routine 2100 for converting a position from a two-dimensional terrain topology to a three-dimensional terrain topology is described below with respect to FIG. 21, according to one embodiment of the present invention. Another routine for converting a position from a two-dimensional terrain topology to a position in a three-dimensional terrain topology 2400 is described below with respect to FIG. 24, according to an embodiment of the present invention.

In step 1030, other render block information related to texture is determined. Determining step 1030 can include determining one or more textures, and one or more texture identifiers. The texture which is determined is the texture associated with a particular render block. One or more textures can be used. In one embodiment, the texture is determined based on two-dimensional terrain data fetched in step 1010. For example, the two-dimensional terrain data can include a texture type identifier information. Texture type identifier information can include flora type or bumpiness. Texture identifiers are then stored in the render block which point to the determined textures. Flora type information identifies terrain characteristics related to ground cover, such as forest, grass, sand, rock, etc. Bumpiness information identifies terrain information related to height, such as whether the terrain is a flat, coastal area, foothill area, rocky mountain range, or Himalaya mountain range. In one implementation, terrain type information can be a two-byte field identifying appropriate flora type and bumpiness values.

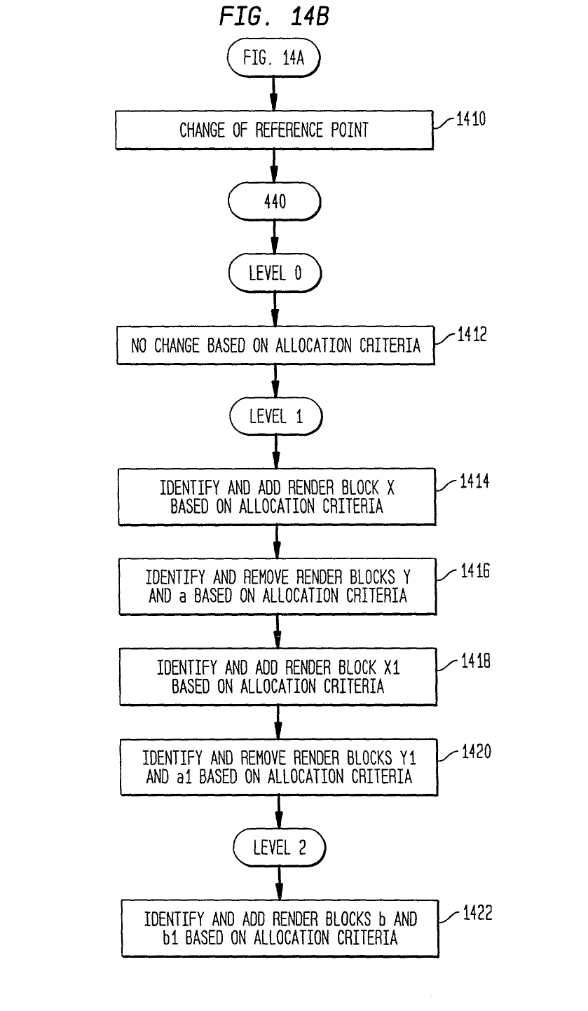

In step 1030, an embodiment where texture identifiers are provided in the fetched two-dimensional terrain data, then the texture identifiers are merely added to a render block. In other embodiments, a routine for creating a texture automatically may be used as described below with respect to FIG. 11. In cases where texture is automatically generated, then an appropriate texture identifier is also generated to identify the texture.

Texture Creation

FIG. 11 is a diagram of a routine 1100 for creating a texture (steps 1110-1130). In step 1110, higher detail terrain data is fetched. The fetched terrain data includes a grid of two-dimensional height samples and terrain-type information. The two-dimensional height samples are fetched which have a level of detail higher than the level of detail associated with a render block to be added. As described above, the terrain data can be fetched from terrain data storage device 305.

In step 1120, a texture is generated having texels at each sample of the fetched two-dimensional height values. In step 1130, the texels of the generated texture are colored based on the terrain type information. For example, if the flora type indicates a grassy ground cover, then the texels are covered with an appropriate greenish color. If the flora type indicates a rocky ground cover, then the texels are covered with an appropriate gray color. The present invention is not limited to these specific flora types and colors. Other types of flora and colors can be used, depending on a particular application and the creativity of a designer. In step 1130, texels can also be colored based on the bumpiness terrain-type information. For example, if a bumpiness type indicates a Himalayas rate of change in height, then texels may be colored to more approximate an extreme mountainous region. If the bumpiness information indicates a foothills, then the texels may be colored to more approximate a foothill region. The present invention is not limited to these examples of bumpiness, and other bumpiness values and texel colors may be used depending on a particular application and creativity of a designer.

Generating Triangle Lists

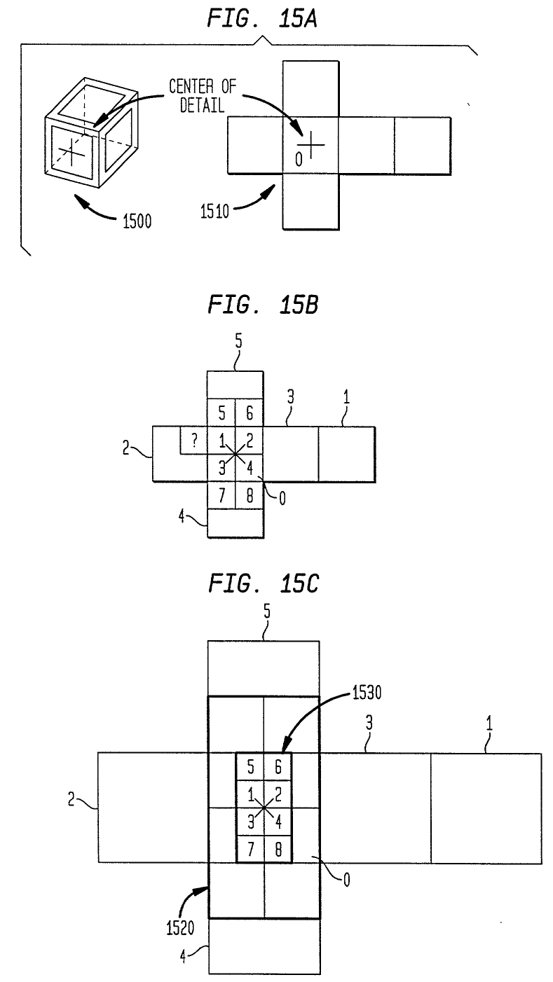

In step 1040, one or more triangle lists are generated. A triangle list is a set of tuples that define the triangles to be rendered. Any conventional triangulation technique can be used to convert the set of three-dimensional vertex locations into sets of tuples. One routine 1200 for generating triangle lists is provided in FIG. 12 according to an embodiment of the invention. In step 1210, the set of vertex locations in three-dimensional coordinate space are triangulated to form four sets of tuples. Each set of tuples corresponds to a corner of an area covered by the render block. In step 1220, the triangulation of vertex locations is adjusted at selected edges of corners to prevent splitting. In particular, at edges where a high and low level of detail occur, extra vertices or primitives are removed. FIGS. 13A and 13B illustrate the removal of extra vertices at an edge to prevent splitting. FIG. 13A shows triangulation for two adjacent render blocks 1310 and 1320. Render block 1310 has terrain data at a relatively high level of detail or resolution, compared to render block 1320. In the example shown in FIG. 13A, render block 1310 is triangulated at twice the resolution of render block 1320. Accordingly, after triangulation of each of the render blocks in step 1210, a splitting condition can occur at the edge of render block 1310 as shown in FIG. 13A. Because triangulation is performed independently for blocks 1310 and 1320, extra vertices a and b are present in the higher level of detail of block 1310, at the edge region. Vertices a and b do not have corresponding vertices in render block 1320. This condition is known as splitting, and during rendering, undesirable effects may be noticeable to a viewer due to the presence of the extra vertices a and b.

In step 1220, triangulation is adjusted to remove the extra vertices a and b. For example, as shown in FIG. 13B, triangulation is adjusted at the edge region to remove vertices a and b in the edge region. All extra vertices are removed such that only vertices in common between the render blocks at an edge are retained. In this way, splitting is avoided at the edge.

It is helpful to further describe the method for managing terrain rendering information 400 with respect to a specific example.

Example Render Block Allocations

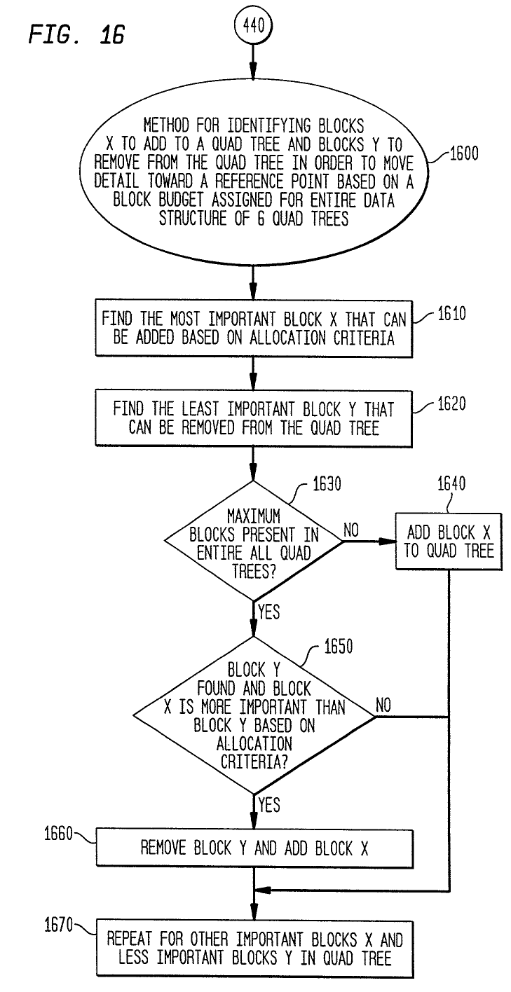

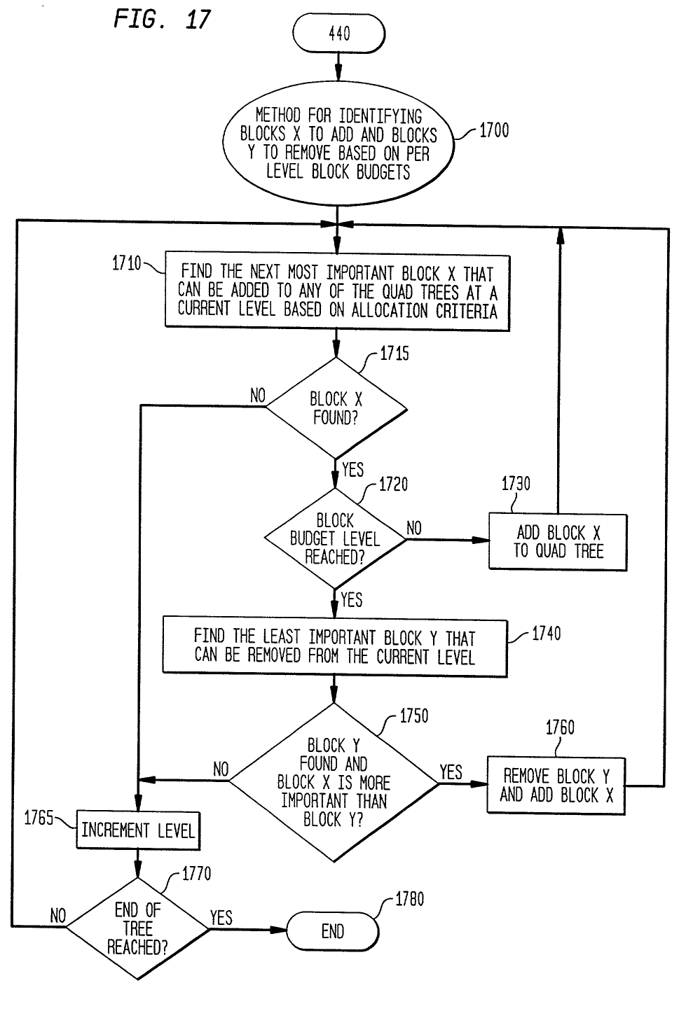

FIGS. 14A and 14B are a flowchart of a render block allocation algorithm according to an embodiment of the present invention. FIGS. 15A-15E are diagrams illustrating different stages of the render block allocation algorithm in one example using the routine of FIGS. 14A and 14B. In this example the allocation criteria used are a maximum budget of 8 blocks per quad tree level and a maximum level difference of 1. The allocation criteria also include distance in determining which blocks are more important. In step 1402, a data structure is initialized and stored having 6 quad trees corresponding to 6 faces of a cube topology. FIG. 15A illustrates 6 faces of a cube topology 1500 and an example layout 1510 of the 6 faces in a set of two dimensional terrain topologies.

Render blocks were then allocated in step 440. As shown in FIG. 1SA, assume reference point information 215 (denoted by an X) identifies the center of detail in the center of the cube face. No render blocks have yet been added to the quad trees. In step 1404, beginning at level 0, six render blocks are identified and added based on the allocation criteria. Each of the six render blocks corresponds to one of the cube faces in layout 1510. Six render blocks were added in level 0 because the level difference constraint of one is satisfied since each of the blocks is on the same level and the maximum budget of eight is not exceeded.

The allocation algorithm then proceeds to level one. In step 1406, eight render blocks are identified and added based on allocation criteria. Level one is unpopulated with render blocks so up to a maximum of eight render blocks can be added. FIG. 15B shows one example allocation of eight render blocks in level one. The allocation of render blocks is based on the distance of the allocated render block from the center of detail. Since the center detail is located at face 0 each of the level 1 render blocks labeled 1-4 are included. Render blocks 5 and 6 in level 1 of face 5 are included. Render blocks 7 and 8 in face 4 are also included. At this point, the maximum budget of eight blocks per level is reached. Assume the distance to a candidate render block is measured from the center of the render block. The present invention, of course, is not limited to this as other points may be used from which to measure distance of render block. The distance from the center of candidate render blocks 5 and 6 in face 5 to the center of detail marked with an X on face 0 is equal. Further this distance is less than the distance to other potential level 1 render blocks in face 5 not shown. Accordingly, candidate render blocks 5 and 6 are added. Similarly, the distance to candidate render blocks 7 and 8 in face 4 is approximately equal. Candidate render blocks 7 and 8 are closer to the center of detail X than other level 1 render blocks in face 4 not shown. Accordingly, candidate render blocks 7 and 8 are also added. At this point, the maximum budget of eight render blocks is reached. Therefore, other level 1 render blocks in faces 1, 2 and 3 are not added.

Further, there are no better candidate render blocks, that is, render blocks in faces 1, 2 or 3 that have a distance shorter than the allocated render blocks 5, 6, 7, or 8. For example, the potential candidate block labeled with question mark ? in FIG. 15B is not closer than any of the other previously allocated candidate render blocks 5 and 6 in face 5 and render block 7 and 8 in face 4. Accordingly, the block labeled ? is not added. Note from observing FIG. 15B, that this process results in blocks near the center of detail getting added first.

The render block allocation algorithm then proceeds to level 2.

In step 1408, eight render blocks are identified and added based on allocation criteria. FIG. 15C shows the eight render blocks labeled 1-8. The process for identifying and adding the eight render blocks in step 1408 is similar to the process described above with respect to the render blocks added in step 1406. Mainly, candidate render blocks 1-4 are identified based on distance information as being important blocks close to the center of detail. Candidate blocks 5, 6, 7 and 8 are identified as being the next most important blocks close to the center of detail X. In this case, level 2 render blocks 1-8, as shown in FIG. 15C, are added to face 0. Two level 2 render blocks 1, 5 are children of level 1 render block 1. Two level 2 render blocks 2, 6 are children of level 1 render block 2. Two level 2 render blocks 3, 7 are children of level 1 render block 3. Two level 2 render blocks 4, 8 are children of level 1 render block 8. Other candidate render blocks in level 2 are either an equal distance away from the center of detail and, therefore, are not any better than the blocks 1-8 or are located at an even greater distance from the center of detail. Assume the data structure 237 only has three levels, level 0, 1 and 2. In this case the algorithm ends until a change of reference point information is made. FIG. 15C shows an area 1520 covered by the eight level 1 render blocks and an area 1530 covered by the eight level 2 render blocks at the conclusion of step 1408.

Change of Reference Point Information

In step 1410, a change of reference point occurs. For example, a camera point position can move. This requires the allocation of render blocks to be considered once again. The process proceeds as before by beginning at level 0 and proceeding through level 2. In step 1412, the allocation of render blocks and level 0 is considered. No change is made based on the allocation criteria. At this level, only 6 candidate render blocks exist and this does to exceed the maximum budget of 8. Accordingly population of render blocks at the root level remains unchanged.

The algorithm proceeds to level 1. In step 1414, a candidate render block x is identified and added based on allocation criteria. FIG. 15D shows the center of detail moved slightly to the left of the original center of detail position. In this case, candidate render block x in level 1 has a distance which is better than previously allocated render blocks. In particular, the candidate render block x is closer to the shifted reference point X than the previously allocated render block y. Accordingly, in step 1414, render block x is added. In step 1416 then render block y is identified as being further from render block x and is removed. Removing allocated render block y means that the previously allocated level 2 block a now has an edge where there is a level distance greater than 1. Since the level distance constraint is a maximum of one level between levels previously allocated, the level 2 render block a is also removed in step 1416.

Steps 1418 and 1420 are similar to steps 1414 and 1416. In step 1418, a candidate render block x1 is identified and added based on allocation criteria. Render block x1 is closer to the shifted center of detail X than the distance from previously allocated render block y1 and the shifted center of detail. In step 1420, previously allocated render block y1 is then removed as it is further away than the newly added candidate render block x1 and therefore not as important. Removing allocated render block y1 means that the previously allocated level 2 block a1 now has an edge where there is a level distance greater than 1. Since the level distance constraint is a maximum of one level between levels previously allocated, the level 2 render block al is also removed in step 1420.

Steps 1414 and 1416 can be performed in any order. In one embodiment, render blocks identified in step 1416 for removal are removed prior to adding the render blocks identified in step 1414. Similarly, render blocks identified in step 1420 for removal are removed prior to adding the render blocks identified in step 1418.

The block allocation algorithm then proceeds to level 2. In step 1422 render blocks b and b1 are identified and added based on allocation criteria. As shown in FIG. 15E, only six render blocks remain allocated in level 2. Accordingly, two more render blocks can be added. Candidate render blocks b and b1 are identified as being the next most important blocks based on their distance from the shifted center of detail. FIG. 15E shows an area 1540 covered by the eight level 1 render blocks and an area 1550 covered by the eight level 2 render blocks at the conclusion of step 1422. At this point none of the candidate blocks in level 0, 1 or 2 can improve the allocation of render blocks. Accordingly, no further work is performed until there is a change of reference point.

Example Render Block Allocation Based on a Block Budget Assigned per Quad Tree

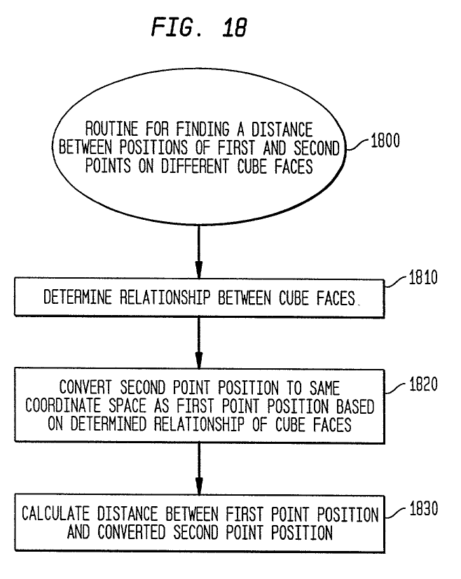

FIG. 16 is a flowchart of a render block allocation algorithm according to an embodiment of the present invention. Render block allocation algorithm 1600 is an example for carrying out a block allocation as described above with respect to step 440. In this embodiment, method 1600 allocates render blocks according to a block budget assigned for each quad tree.

Method 1600 includes step 1610-1670 as shown in FIG. 16. For convenience, blocks which are identified to add are labeled x. Blocks which are identified to be removed are labeled y.

In step 1610, the most important block x is found that can be added based on allocation criteria. In step 1620, the least important block y is found that can be removed from a quad tree. Step 1630 a check is made on whether the maximum blocks present in an entire quad tree has been reached. If the maximum has not been reached then the most important block x found in step 1610 is added to the quad tree (step 1640). Control then proceeds to step 1670. If the maximum blocks are present in the entire quad tree then control proceeds to step 1650. In step 1650, a check is made to determine whether a candidate render block y has been found and whether block x is more important than block y based on allocation criteria. If the block x found to be added is more important than a block y then the block y is removed and block x is added to the level of the quad tree (step 1660). Otherwise, control then proceeds to step 1670.

In step 1670, control proceeds to repeat step 1610-1660 for other next most important blocks x which are found and for other less important blocks y which are found in the quad tree. In this way steps 1610-1670 are repeated until the allocation of rendered blocks cannot be improved.

Example Render Block Allocation Algorithm Based on Block Budgets Assigned Per Level

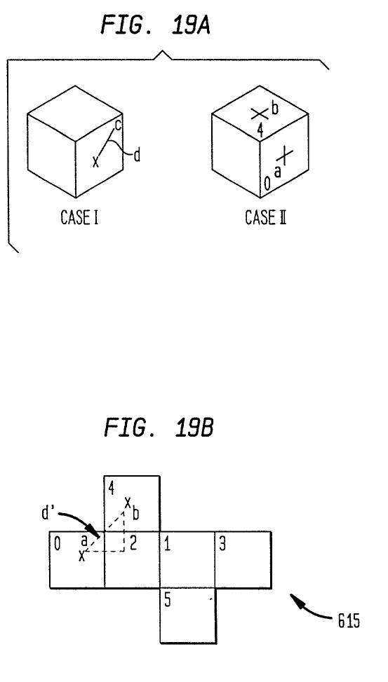

FIG. 17 is a diagram of a method 1700. Method 1700 identifies candidate render blocks x to add and candidate blocks y to remove in order to move detail toward a reference point based on block budgets assigned per level (steps 1710-1780). In step 1710, the next most important block x is found that can be added to any of the six quad trees at a current level based on allocation criteria. In one example, method 1700 begins with the current level set at the root level. In another example, method 1700 can start at a pre-selected level.

In step 1715, a check is made to determine whether the next most important block x has been found in step 1710. If no, this means no better render blocks in this level need to be added. Control then proceeds to step 1765 to increment the level. If yes, a next most important block X has been found then control proceeds to step 1720.

In step 1720, a check is made to determine whether the block budget level has been reached. If no, this means the block budget level is not reached and block X is added to the quad tree (step 1730). Control then proceeds to step 1710 to see if a next most important block can be found. Otherwise, if the block budget level is reached, control proceeds to step 1740.

In step 1740, the least important block y is found that can be removed from the current level. In step 1750, a check is made to determine whether a least important block y has been found and whether block x found in step 1710 is more important than block y. If a block y has not been found or block x is not more important than block y then control proceeds to step 1765 to consider the next level. In step 1765, the current level is incremented to the next deeper level in the quad trees. Otherwise, when a block y is found and a block x is more important than block y in step 1750, then control proceeds to step 1760. In step 1760, the least important block y is removed and the more important block x is added to the appropriate quad tree for block x. Control then proceeds to step 1710 to see if a next most important block can be found.

After step 1765, control proceeds to step 1770. In step 1770, a check is made to determine whether or not the end of the tree is reached. If the end of the tree is not reached then control proceeds to step 1710 to see if a next most important block can be found. Otherwise when the end of the tree is reached the algorithm ends (step 1780) and control proceeds to step 460 of FIG. 4.

Position Conversion

Converting a Position from 3-D to 2-D

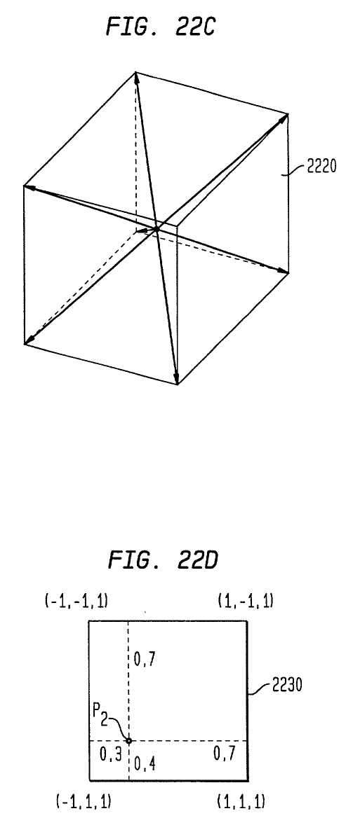

FIG. 20 is a flowchart of routine 2000. Routine 2000 converts a position in a three-dimensional terrain topology to a position in a set of two-dimensional terrain topologies according to an embodiment of the present invention. Routine 2000 include steps 2010-2070. For convenience, the operation of routine 2000 is described with respect to an example cube topology and a set of two dimensional terrain topologies represented by a data structure having 6 quad trees corresponding to 6 cube faces. FIG. 22A shows a point P3 on a sphere 2210 being converted to a point P2 on a cube face of cube 2220.

In step 2010, a set of unit reference vectors are stored. The set of unit reference vectors essentially define a coordinate space as shown in FIG. 22B where a set of unit reference specters indicate positive x, y, z directions. In step 2020, sets of 4 corner vectors are stored. The sets of 4 corner vectors correspond to two dimensional terrain topologies. FIG. 22C shows an example of sets of 4 corner vectors corresponding to the 6 bases of a cubed topology 2220. Each of the sets of 4 corner vectors extend from a common point in the center of the cubed topology 220 to respective corner points of a respected cube face.

In step 2030, a three dimensional position information is received. For example the three dimensional position information can be an address of a point P3 on a sphere 2210. The three dimensional position information can consist of three coordinate values (x, y, z) defining a vector P3 with respect to an origin O in the center of the sphere 2210. These three coordinate values define the position of the point P3 in the three dimensional terrain topology of the sphere 2210 coordinate space.

In step 2040, the three dimensional position information is normalized.

Any conventional normalization technique can be used. For example the vector extending from an origin 0 to point P3 can be normalized by dividing the coordinate values x, y, z by the magnitude of the distance between 0 and P3. This results in a normalized vector P3 having a unit length as shown in FIG. 22B.

In step 2050, a specific two dimensional terrain topology is determined. This two dimensional terrain topology corresponds to the three dimensional position information based on the set of unit reference vectors. For example, a cube face 2230 would be the two dimensional terrain topology identified in step 2050 based on the normalized three dimensional position vector P3 and the set of unit vectors (+x, +y, +z).

In step 2060, a fractional position is determined within the two dimensional terrain topology. This fractional position is determined based on an interpolation between a respective set of 4 corner vectors. For example, as shown in FIG. 22D, a fractional position P2 would then be on cube face 2230 is determined based on 4 corner vectors corresponding to the corner vertices of the cube face 2230. In the example of FIG. 22B, the corner vertices are labeled (−1, −1, 1), (1, −1, 1), (−1, 1, 1), (1, 1, 1). The fractional position can be the fractional information along one dimension (e.g. 0.3 of the entire distance of cube face along x axis) and a fractional information along another dimension (e.g. 0.4 of the entire distance of cube face along y axis) for point P2 as shown in FIG. 22D. In step 2070, the fractional position is then converted to a position P2 within the two dimensional terrain topology. This position can be a cube face identifier and two-dimensional block address.

Converting a Position from 2D to 3D

FIG. 21 shows a method 2100. Method 2100 converts a position in a set of two dimensional terrain topologies to a position in a three dimensional terrain topology (steps 2110-2140). In step 2110, two dimensional position information is received. For example the two dimensional information can identify a position within a cube face. In one example discussed above the two dimensional position information can be an address of position P2.

In step 2120, the two dimensional position information point P2 is converted to a fractional position within the two dimensional terrain topology. In step 2130, an interpolation is made between 4 corner vectors based on the fractional position to obtain a result vector. The result vector is then scaled based on the height of terrain (step 2140). In this way, the two dimensional terrain topology of a cube face position is converted to a position in the 3D coordinate space of a sphere topology. In step 2140, the resulting vector can be scaled based on any reference height. In one example, the radius of the earth is used. In this way, the virtual world is generated based on a sphere topology having a radius equal to that of the earth.

Converting a Position in 3D to 2D

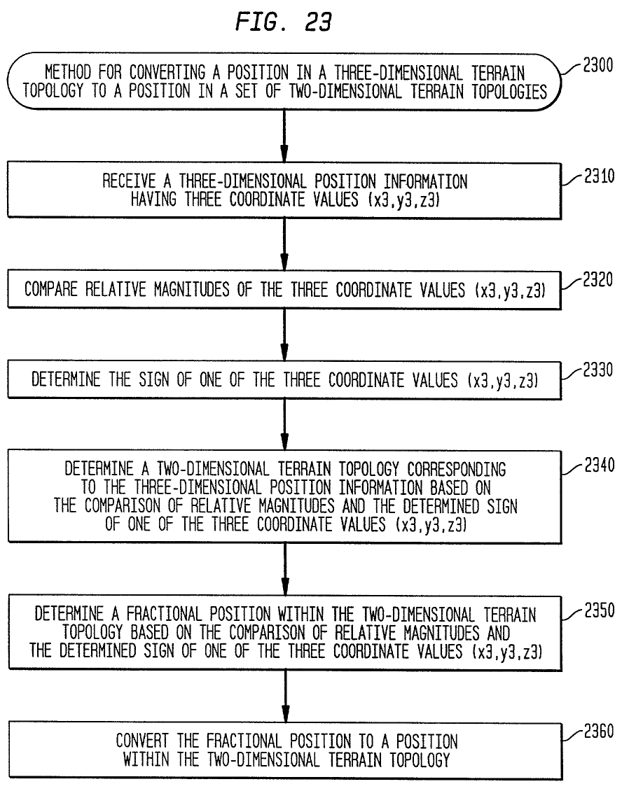

FIG. 23 is a flowchart of routine 2300. Routine 2300 converts a position in a three dimensional terrain topology to a position in a set of two dimensional terrain topologies according to the embodiment of the present invention (steps 2310-2360). For example, to describe the operation of method 2300 consider two points. One point P3 has a three dimensional coordinate given by the values x3, y3, z3. It is converted to a position in a set of two dimensional terrain topologies given by two dimensional position address. The two dimensional position address has a face identifier that identifies a cube face and a two dimensional position coordinate having two coordinate values (x2, y2). Step 2310, three dimensional position information having three coordinate values (x3, y3, z3) is received. In step 2320, a comparison is made of the relative magnitudes of 3 coordinate values (x3, y3, z3). Step 2330, the sign (+/−) of one of the three coordinate values x3, y3, z3 is determined.

In step 2340, a two dimensional terrain topology (i.e., acute phase) is determined. This two dimensional terrain topology or cube face corresponds to the three dimensional position information. The two dimensional terrain topology is determined based on the comparison in step 2320 and the determined sign in step 2330.

In step 2350, a fractional position within the two dimensional terrain topology is determined based on the comparison of step 2320 and the determined sign of step 2330. In one example implementation steps 2320,2330 and 2340 are carried out according to the following logic:

abs(m) is a function that returns the magnitude of the value passed to it.
For example, abs(−1.2) and abs(1.2) would both return 1.2.
if abs(x3) > abs(y3) and abs(x3) > abs(z3) then
if x3 is positive
face = 3
xloc = z3/3x
yloc = y3/x3
else
face = 2
xloc = −z3/x3
yloc = −y3/x3
else of abs(y3) > abs(z3)
if y3 is positive
face = 5
xloc = x3/y3
yloc = z3/y3
else
face = 4
xloc = −x3/y3
yloc = −z3/y3
else
if z3 is positive
face = 0
xloc = −x3/z3
yloc = y3/z3
else
face = 1
xloc = x3/z3
yloc = y3/z3

In step 2360, the fractional position determined in step 2350 is converted to a position within the two dimensional terrain topology. In particular, the fractional position (xloc, yloc) are numbers between −1 and 1. These numbers can be used as two dimensional coordinates but are preferably converted to numbers and arranged between 0 and a maximum value (range [0, max]). In step 2360 then the fractional position xloc, yloc is converted to a two dimensional position x2, y2 according to the equations in the following text box 2:

x2 = (xloc * max + max)/2
y2 = (yloc * max + max)/2

Converting a Position from 2D to 3D

FIG. 24 is a flowchart of routine 2400 (steps 2410-2440). Routine 2400 shows a method for converting the position in a set of two dimensional terrain topologies to a position in a three dimensional terrain topology. For convenience, this method will be described with respect to an example position P2 identified by a face identifier and two coordinates x2, y2. Instep 2410, the two dimensional position information having two coordinate values (x2, y2) is received. The two dimensional terrain topology identifier (face). In step 2420, the two coordinate values x2, y2 are converted to a fractional position (xloc, yloc) within the two dimensional terrain topology. For example, the conversion to a fractional position can be formed according to the equations given in text box 3 below:

xloc = (x2/2 − max)/ max
yloc = (y2/2 − max)/ max

In step 2430, a raw position is determined within the three dimensional terrain topology. The raw position has three coordinate values (x3, y3, z3). This determination of a raw position is based on the two dimensional terrain topology identifier (face) and the fractional position (xloc, yloc). In one example implementation, the raw position is determined as set forth below in the following text box 4:

if face is 0
x3 = xloc
y3 = yloc
z3 = 1.0
else if face is 1
x3 = −xloc
y3 = −yloc
z3 = −1.0
else if face is 2
x3 = −1.0
y3 = yloc
z3 = xloc
else if face is 3
x3 = 1.0
y3 = yloc
z3 = xloc
else if face is 4
x3 = xloc
y3 = −1.0
z3 = yloc
else if face is 5
x3 = xloc
y3 = −1.0

In step 2440, the raw position determined in step 2430 is scaled. In one embodiment, the raw position is scaled based on the base height of a terrain. For instance the scaling can include normalizing the three coordinate values x3, y3, z3 and multiplying each component by the desired height such as the Earth's radius.

Example Graphics Implementations

The present invention is described with reference to example computer graphics environments (FIGS. 25-27). These example environments are illustrative and not intended to limit the present invention.

Example Architecture

FIG. 25 illustrates a block diagram of an example computer architecture 2500 in which the various features of the present invention can be implemented. It is an advantage of the invention that it may be implemented in many different ways, in many environments, and on many different computers or computer systems. Architecture 2500 includes six overlapping layers. Layer 2552 represents a high level software application program. Layer 2553 represents a three-dimensional (3D) graphics software tool kit, such as OPENGL PERFORMER, available from Silicon Graphics, Incorporated, Mountain View, Calif. Layer 2555 represents a graphics application programming interface (API), which can include, but is not limited to OPENGL, available from Silicon Graphics, Incorporated, DirectX available from Microsoft, or Renderman available from Pixar.

Layer 2554 represents system support such as operating system and/or windowing system support. Layer 2556 represents firmware. Finally, layer 2558 represents hardware, including graphics hardware. Hardware 2558 can be any hardware or graphics hardware including, but not limited to, a computer graphics processor (single chip or multiple chip), a personal computer, a specially designed computer, an interactive graphics machine, a gaming platform, a low end game system, a game console, set top box, workstation, a network architecture, server, et cetera. Some or all of the layers 2552-2558 of architecture 2500 can be installed in most commercially available computers.

As will be apparent to a person skilled in the relevant art after reading the description of the invention herein, various features of the invention can be implemented in any one of the layers 2552-2558 of architecture 2500, or in any combination of layers 2552-2558 of architecture 2500.

In one embodiment, terrain data manager 210 and render block manager 220 are implemented in application program layer 2552. Terrain data manager 210 and render block manager 220 are control logic (e.g., software) that is part of an application layer 2552 that provides control steps necessary to carry out the routines described above with respect to FIGS. 4,9-12, 14, 16-18, 20-21, and 23-24. Renderer 240 includes an API layer 2555 and graphics hardware 2558 of architecture 2500.

Host and Graphics Subsystem

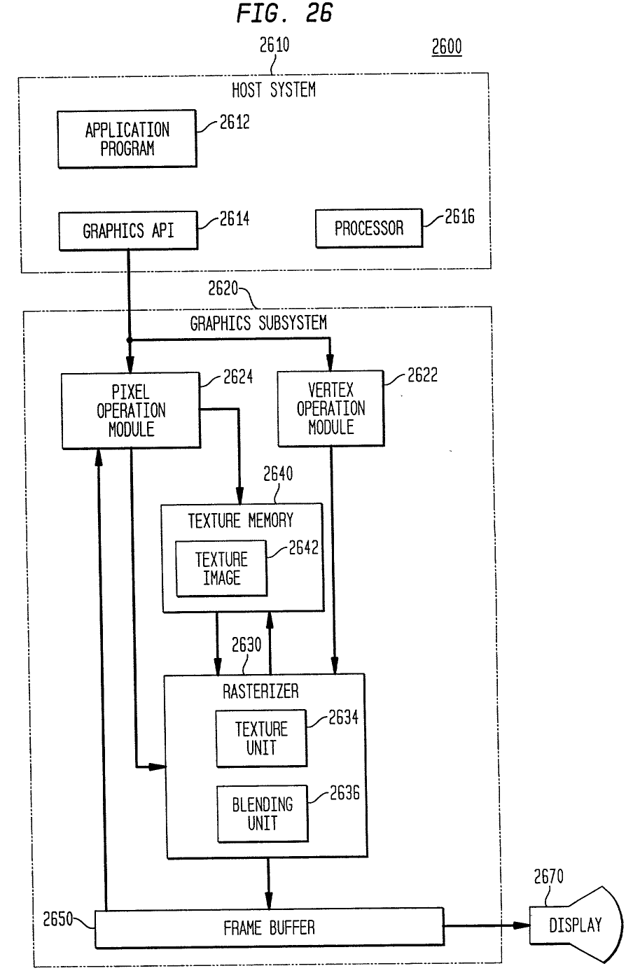

FIG. 26 illustrates an example graphics system 2600 according to an embodiment of the present invention. Graphics system 2600 comprises a host system 2610, a graphics subsystem 2620, and a display 2670. Each of these features of graphics system 2600 is further described below.

Host system 2610 comprises an application program 2612, a hardware interface or graphics API 2614, and a processor 2616. Application program 2612 can be any program requiring the rendering of a computer image or scene. The computer code of application program 2612 is executed by processor 2616. Application program 2612 assesses the features of graphics subsystem 2620 and display 2670 through hardware interface or graphics API 2614. In one example embodiment, terrain data manager 210 and render block manager 220 are control logic (e.g., software) that is part of application 2612. Renderer 240 includes API 2614 and graphics hardware 2620.

Graphics subsystem 2620 comprises a vertex operation module 2622, a pixel operation module 2624, a rasterizer 2630, a texture memory 2640, and a frame buffer 2650. Texture memory 2640 can store one or more texture images 2642. Texture memory 2640 is connected to a texture unit 2634 by a bus or other communication link (not shown). Rasterizer 2630 comprises texture unit 2634 and a blending unit 2636. The operation of these features of graphics system 400 would be known to a person skilled in the relevant art given the description herein.

In embodiments of the present invention, texture unit 2634 can obtain either a point sample, a bilinearly filtered texture sample, or a trilinearly filtered texture sample from texture image 2642. Blending unit 2636 blends texels and/or pixel values according to weighting values to produce a single texel or pixel. The output of texture unit 2634 and/or blending module 2636 is stored in frame buffer 2650. Display 2670 can be used to display images or scenes stored in frame buffer 2650.

An embodiment of the invention shown in FIG. 26 has a multipass graphics pipeline. It is capable of operating on each pixel of an object (image) during each pass that the object makes through the graphics pipeline. For each pixel of the object, during each pass that the object makes through the graphics pipeline, texture unit 2634 can obtain a single texture sample from the texture image 2642 stored in texture memory 2640.

Example Computer System

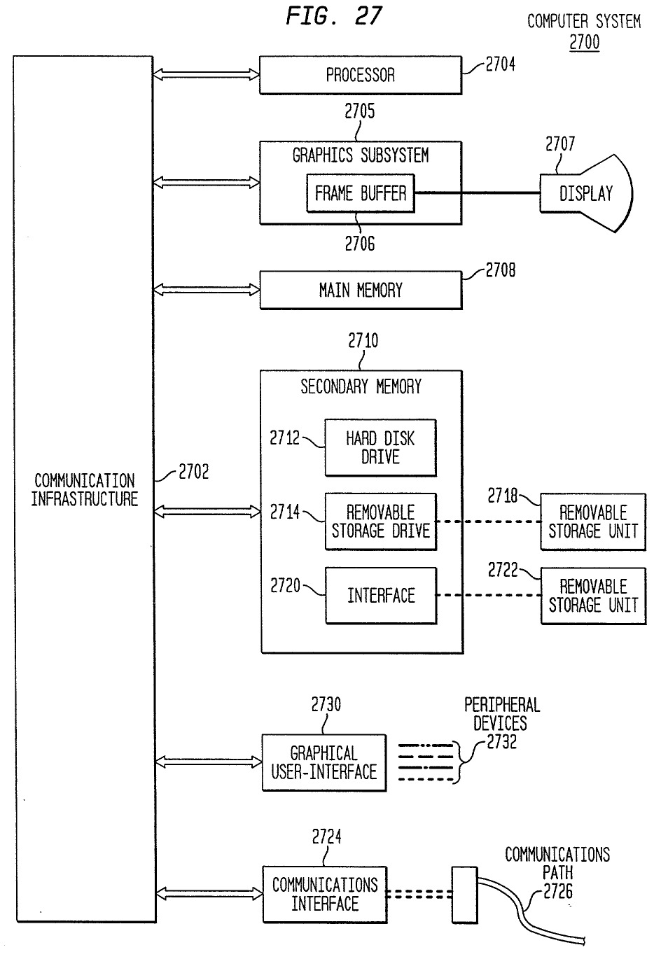

Referring to FIG. 27, an example of a computer system 2700 is shown, which can be used to implement computer program product embodiments of the present invention. This example computer system is illustrative and not intended to limit the present invention. Computer system 2700 represents any single or multi-processor computer. Single-threaded and multi-threaded computers can be used. Unified or distributed memory systems can be used.

Computer system 2700 includes one or more processors, such as processor 2704, and one or more graphics subsystems, such as graphics subsystem 2705. One or more processors 2704 and one or more graphics subsystems 2705 can execute software and implement all or part of the features of the present invention described herein. Graphics subsystem 2705 can be implemented, for example, on a single chip as a part of processor 2704, or it can be implemented on one or more separate chips located on a graphic board. Each processor 2704 is connected to a communication infrastructure 2702 (e.g., a communications bus, cross-bar, or network). After reading this description, it will become apparent to a person skilled in the relevant art how to implement the invention using other computer systems and/or computer architectures.

Computer system 2700 also includes a main memory 2708, preferably random access memory (RAM), and can also include secondary memory 2710. Secondary memory 2710 can include, for example, a hard disk drive 2712 and/or a removable storage drive 2714, representing a floppy disk drive, a magnetic tape drive, an optical disk drive, etc. The removable storage drive 2714 reads from and/or writes to a removable storage unit 2718 in a well-known manner. Removable storage unit 2718 represents a floppy disk, magnetic tape, optical disk, etc., which is read by and written to by removable storage drive 2714. As will be appreciated, the removable storage unit 2718 includes a computer usable storage medium having stored therein computer software and/or data.

In alternative embodiments, secondary memory 2710 may include other similar means for allowing computer programs or other instructions to be loaded into computer system 2700. Such means can include, for example, a removable storage unit 2722 and an interface 2720. Examples can include a program cartridge and cartridge interface (such as that found in video game devices), a removable memory chip (such as an EPROM, or PROM) and associated socket, and other removable storage units 2722 and interfaces 2720 which allow software and data to be transferred from the removable storage unit 2722 to computer system 2700.

In an embodiment, computer system 2700 includes a frame buffer 2706 and a display 2707. Frame buffer 2706 is in electrical communication with graphics subsystem 2705. Images stored in frame buffer 2706 can be viewed using display 2707.

Computer system 2700 can also include a communications interface 2724. Communications interface 2724 allows software and data to be transferred between computer system 2700 and external devices via communications path 2726. Examples of communications interface 2724 can include a modem, a network interface (such as Ethernet card), a communications port, etc. Software and data transferred via communications interface 2724 are in the form of signals which can be electronic, electromagnetic, optical or other signals capable of being received by communications interface 2724, via communications path 2726. Note that communications interface 2724 provides a means by which computer system 2700 can interface to a network such as the Internet.

Computer system 2700 can include one or more peripheral devices 2732, which are coupled to communications infrastructure 2702 by graphical user-interface 2730. Example peripheral devices 2732, which can from a part of computer system 2700, include, for example, a keyboard, a pointing device (e.g., a mouse), a joy stick, and a game pad. Other peripheral devices 2732, which can form a part of computer system 2700 will be known to a person skilled in the relevant art given the description herein.

The present invention can be implemented using software running (that is, executing) in an environment similar to that described above with respect to FIG. 27. In this document, the term “computer program product” is used to generally refer to removable storage unit 2718, or a hard disk installed in hard disk drive 2712. The term “computer data signal” refers to a carrier wave or other signal carrying software over a communication path 2726 (wireless link or cable) to communication interface 2724. A computer useable medium can include magnetic media, optical media, or other recordable media, or media that transmits a carrier wave. These computer program products and computer data signals are means for providing software (e.g. control logic) to computer system 2700.

Computer programs (also called computer control logic) are stored in main memory 2708 and/or secondary memory 2710. Computer programs can also be received via communications interface 2724. Such computer programs, when executed, enable the computer system 2700 to perform the features of the present invention as discussed herein. In particular, the computer programs, when executed, enable the processor 2704 to perform the features of the present invention. Accordingly, such computer programs represent controllers of the computer system 2700.

In an embodiment where the invention is implemented using software, the software may be stored in a computer program product and loaded into computer system 2700 using removable storage drive 2714, hard drive 2712, or communications interface 2724. Alternatively, the computer program product may be downloaded to computer system 2700 over communications path 2726. The control logic (software), when executed by the one or more processors 2704, causes the processor(s) 2704 to perform the functions of the invention as described herein.

In another embodiment, the invention is implemented primarily in firmware and/or hardware using, for example, hardware components such as application specific integrated circuits (ASICs). Implementation of a hardware state machine so as to perform the functions described herein will be apparent to a person skilled in the relevant art.

Conclusion

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A terrain renderer, comprising:
a storage device that stores a data structure having render blocks; and
a render block manager that manages the allocation of render blocks in said data structure.

2. The terrain renderer of claim 1, wherein said render block manager manages the allocation of render blocks in said data structure based on current reference point information, whereby, render blocks are maintained which have terrain primitive data covering an area based on the current reference point information.

3. The terrain renderer of claim 1, wherein said render block manager manages the allocation of render blocks in said data structure based on at least one allocation criterion.

4. The terrain renderer of claim 3, wherein said render block manager manages the allocation of render blocks in said data structure based on at least one allocation criterion selected from the group of: distance of a candidate render block from current reference point information, size of a candidate render block, recent visibility of a candidate render block, presence of parent render block, presence of a child render block for the candidate render block, presence of a child render block for a neighbor render block of the candidate render block, a level difference constraint, and a maximum budget of render blocks.

5. The terrain renderer of claim 3, wherein said render block manager manages the allocation of render blocks in said data structure based on the following allocation criteria: distance of a candidate render block from current reference point information, size of a candidate render block, recent visibility of a candidate render block, presence of parent render block, presence of a child render block for the candidate render block, presence of a child render block for a neighbor render block of the candidate render block, a level difference constraint, and a maximum budget of render blocks.

6. The terrain renderer of claim 3, wherein said render block manager manages the allocation of render blocks in said data structure based on at least one allocation criterion comprising a distance of a candidate render block from current reference point information.

7. The terrain renderer of claim 3, wherein said render block manager manages the allocation of render blocks in said data structure based on allocation criteria including a distance of a candidate render block from current reference point information, a level difference constraint, and a maximum budget of render blocks.

8. The terrain renderer of claim 3, wherein said data structure comprises six quad trees, each quad tree having one or more levels, and wherein said render block manager manages the allocation of render blocks in said data structure based on at least one allocation criterion including a budget of render blocks based on a maximum number of render blocks allowed per level of each quad tree.

9. The terrain renderer of claim 3, wherein said data structure comprises six quad trees, each quad tree having one or more levels, and wherein said render block manager manages the allocation of render blocks in said data structure based on at least one allocation criterion including a budget of render blocks based on a maximum number of render blocks allowed in each quad tree.

10. The terrain renderer of claim 1, wherein said data structure represents a three-dimensional terrain topology of a virtual world with a set of two-dimensional terrain topologies.

11. The terrain renderer of claim 10, wherein the three-dimensional terrain topology of the virtual world comprises a spheric terrain topology, and the set of two-dimensional terrain topologies comprises faces of a cube, and said data structure comprises six quad trees, each quad tree corresponding to a respective cube face.

12. The terrain renderer of claim 11, wherein each render block includes primitive data defining primitives for an area of terrain to be rendered.

13. The terrain renderer of claim 12, wherein each render block includes a texture identifier that identifies a texture to be applied in rendering the area of terrain defined by said primitive data.

14. The terrain renderer of claim 13, wherein the area of terrain to be rendered based on each render block has four corners, and said primitive data comprises four triangle lists corresponding to the respective four corners.

15. The terrain renderer of claim 13, wherein each render block further includes zero or one parent pointer, zero to four child pointers, a render block address in a two-dimensional space of a respective cube face, and a set of vertex locations in a three-dimensional coordinate space.

16. The terrain renderer of claim 1, wherein each render block includes primitive data defining primitives for an area of terrain to be rendered.

17. The terrain renderer of claim 16, wherein each render block includes a texture identifier that identifies a texture to be applied in rendering the area of terrain defined by said primitive data.

18. The terrain renderer of claim 3, wherein said data structure comprises six quad trees, each quad tree having one or more levels, and said render block manager identifies one or more candidate render blocks to add and remove from each level of each quad tree based on said at least one allocation criterion, and adds and removes a number of the identified candidate render blocks from each level of each quad tree based on said at least one allocation criterion.

19. The terrain renderer of claim 1, wherein each allocated render block further includes primitive data representing samples of terrain data to be rendered, and wherein said render block manager allocates render blocks in said data structure for each change of reference point information such that said primitive data in the allocated render blocks samples an area of terrain at greater levels of detail nearest the current reference point information even as the current reference point information changes, whereby, appropriate terrain rendering information is maintained efficiently in said data structure during movement of a reference point in a real-time application.

20. The terrain renderer of claim 3, wherein said render block manager initializes said data structure and fills each allocated render block with corresponding render block information.

21. The terrain renderer of claim 3, wherein for each render block to be added to said data structure, said render block manager fetches two-dimensional terrain data, from a terrain data source, and converts said fetched two-dimensional terrain data into a set of three-dimensional vertex locations.

22. The terrain renderer of claim 21, wherein for each render block to be added to said data structure, said render block manager determines a texture identifier, set of vertex-texture indices, and generates triangle lists.

23. The terrain renderer of claim 3, wherein for each render block to be allocated to said data structure, said render block manager determines a texture identifier, set of vertex-texture indices, and generates triangle lists.

24. The terrain renderer of claim 1, wherein said render block manager further comprises:
a render block allocator that identifies render blocks to be added or removed from said data structure based on current reference point information and allocation criteria; and
a render block generator that fills information in each render block to be added to said data structure.

25. The terrain renderer of claim 24, wherein said render block generator further comprises a texture module that identifies a texture for each allocated render block.

26. The terrain renderer of claim 24, further comprising a texture creator that automatically creates the identified texture for each allocated render block.

27. The terrain renderer of claim 26, wherein said texture creator fetches terrain data comprising samples at a higher level of detail than the primitive data in a corresponding render block, generates a texture having texels at the samples of the fetched terrain data, and colors said texels based on terrain type information.

28. The terrain renderer of claim 26, wherein said terrain type information includes at least one of flora type and bumpiness information.

29. The terrain renderer of claim 24, wherein said render block generator further comprises a triangulation module that triangulates a set of vertex locations in three-dimensional coordinate space to form sets of tuples corresponding to four quadrants of an area of terrain represented by a render block, and adjusts the triangulation of vertex locations at selected edges of the quadrants to avoid splitting.

30. The terrain renderer of claim 29, wherein said triangulation module removes extra vertex locations at edges which are a boundary between render blocks having relatively low and high level of detail.

31. The terrain renderer of claim 24, further comprising a cube/sphere conversion module that converts a position in a three-dimensional terrain topology of a virtual world to a position in a set of two-dimensional topologies.

32. The terrain renderer of claim 24, further comprising a cube/sphere conversion module that converts a position in a set of two-dimensional topologies to a position in a three-dimensional terrain topology of a virtual world.

33. The terrain renderer of claim 24, said render block allocator further comprises a distance calculator that determines a distance between two points on the same or different cube faces.

34. A method for managing terrain rendering information, comprising:
(A) storing a data structure to represent a three-dimensional terrain topology of a virtual world with a set of two-dimensional terrain topologies; and
(B) allocating render blocks in the data structure based on a current reference point information such that render blocks are allocated which have terrain primitive data covering an area based on the current reference point information.

35. A method, comprising:
(A) storing a data structure to represent a three-dimensional terrain topology of a virtual world with a set of two-dimensional terrain topologies; and
(B) managing an allocation of render blocks in the data structure based on a current reference point information such that render blocks are allocated which have terrain primitive data covering an area based on the current reference point information.

36. The method of claim 35, wherein said managing step (B) comprises managing the allocation of render blocks in the data structure based on at least one allocation criterion.

37. The method of claim 36, wherein said managing step (B) comprises managing the allocation of render blocks in the data structure based on at least one allocation criterion comprising a distance of a candidate render block from current reference point information.

38. The method of claim 36, wherein said managing step (B) comprises managing the allocation of render blocks in the data structure based on allocation criteria including a distance of a candidate render block from current reference point information, a level difference constraint, and a maximum budget of render blocks.

39. The method of claim 36, further comprising the step of filling each allocated render block with corresponding render block information.

40. The method of claim 36, wherein said filling step comprises filling each allocated render block with at least one of primitive data defining primitives for an area of terrain to be rendered and a texture identifier that identifies a texture to be applied in rendering the area of terrain defined by the primitive data.

41. The method of claim 36, wherein the data structure comprises six quad trees, each quad tree having one or more levels, and said managing step (b) comprises:
identifying one or more candidate render blocks to add and remove from each level of each quad tree based on at least one allocation criterion,
adding a number of the identified candidate render blocks from a level of a quad tree based on at least one allocation criterion; and
removing a number of the identified candidate render blocks from a level of a quad tree based on at least one allocation criterion.

42. The method of claim 36, wherein the data structure comprises six quad trees, each quad tree having one or more levels, and each allocated render block further includes primitive data representing samples of terrain data to be rendered, and wherein said managing step (b) comprises allocating render blocks in the data structure for each change of reference point information such that the primitive data in the allocated render blocks samples an area of terrain at greater levels of detail nearest the current reference point information even as the current reference point information changes, whereby, appropriate terrain rendering information is maintained efficiently in said data structure during movement of a reference point in a real-time application.

43. The method of claim 36, wherein said managing step (b) comprises for each new render block to be added to the data structure:
fetching two-dimensional terrain data from a terrain data source, and converting the fetched two-dimensional terrain data into a set of three-dimensional vertex locations.

44. The method of claim 36, further comprising:
creating a texture corresponding for an allocated render block.

45. The method of claim 44, wherein said texture creating step comprises:
fetching terrain data comprising samples at a higher level of detail than the primitive data in a corresponding render block;
generating a texture having texels at the samples of the fetched terrain data; and
coloring the texels based on terrain type information.

46. The method of claim 36, further comprising:
triangulating a set of vertex locations in three-dimensional coordinate space to form sets of tuples corresponding to four quadrants of an area of terrain represented by a render block; and
adjusting the triangulation of vertex locations at selected edges of the quadrants to avoid splitting.

47. The method of claim 46, wherein said adjusting step includes removing extra vertex locations at edges which are a boundary between render blocks having relatively low and high levels of detail.

48. The method of claim 36, further comprising:
converting a position in a three-dimensional terrain topology of a virtual world to a position in a set of two-dimensional topologies.

49. The method of claim 48, wherein said converting step comprises:
receiving a 3D position coordinate representative of the position in the three-dimensional terrain topology;
normalizing the 3D position coordinate;
determining a two-dimensional terrain topology based on a set of unit reference vectors;
determining a fractional position within the determined two-dimensional terrain topology based on an interpolation between four corner vectors; and
converting the determined fractional position to a position within the determined two-dimensional terrain topology.

50. The method of claim 48, wherein said converting step comprises:
receiving a 3D position coordinate having three coordinate values representative of the position in the three-dimensional terrain topology;
comparing relative magnitudes of the three coordinate values;
determining the sign of one of the three coordinate values;
determining a two-dimensional terrain topology based on the comparison of relative magnitudes and the determined sign;
determining a fractional position within the determined two-dimensional terrain topology based on the comparison of relative magnitudes and the determined sign; and
converting the determined fractional position to a position within the determined two-dimensional terrain topology.

51. The method of claim 36, further comprising:
converting a position in a set of two-dimensional terrain topologies to a position in a three-dimensional terrain topology of a virtual world.

52. The method of claim 51, wherein said converting step comprises:
receiving a position in a set of two-dimensional terrain topologies;
converting the position to a fractional position within a corresponding two-dimensional terrain topology;
interpolating between four corner vectors based on the fractional position to obtain a resultant vector; and
scaling the resultant vector based on a reference terrain height to obtain the position in a three-dimensional terrain topology of a virtual world.

53. The method of claim 51, wherein said converting step comprises:
receiving a position having two coordinate values representative of the position in a set of two-dimensional terrain topologies;
converting the two coordinate values to a fractional position within a corresponding two-dimensional terrain topology;
determining a raw position having three coordinate values based on the a two-dimensional terrain topology identifier and the fractional position; and
scaling the raw position based on a reference terrain height to obtain the position in a three-dimensional terrain topology of a virtual world.

54. A computer program product comprising a computer useable medium having computer program logic for enabling at least one processor in a computer system to manage rendering information, said computer program logic comprising:
means for enabling the at least one processor to access a data structure that represents a three-dimensional terrain topology of a virtual world with a set of two-dimensional terrain topologies; and
means for enabling the at least one processor to manage an allocation of render blocks in the data structure based on a current reference point information such that render blocks are allocated which have terrain primitive data covering an area based on the current reference point information.

55. A computer data signal embodied in a wired or wireless medium comprising computer program logic for enabling at least one processor in a computer system to manage rendering information, said computer program logic comprising:
means for enabling the at least one processor to access a data structure that represents a three-dimensional terrain topology of a virtual world with a set of two-dimensional terrain topologies; and
means for enabling the at least one processor to manage an allocation of render blocks in the data structure based on a current reference point information such that render blocks are allocated which have terrain primitive data covering an area based on the current reference point information.

56. A system for rendering terrain for a three-dimensional terrain topology of a virtual world, comprising:
a data structure that includes six quad trees,
wherein each quad tree corresponds to a respective cube face of a cube representative of the three-dimensional terrain topology.
